(19) United States
(12) Patent Application Publication
(10) Pub. No.: US 2015/0146125 A1
(43) Pub. Date: May 28, 2015

(54) LIQUID CRYSTAL DISPLAY PANEL, LIQUID CRYSTAL DISPLAY APPARATUS, AND THIN FILM TRANSISTOR ARRAY SUBSTRATE

(71) Applicant: Sharp Kabushiki Kaisha, Osaka-shi, Osaka (JP)

(72) Inventors: Yuichi Kita, Osaka-shi (JP); Takatomo Yoshioka, Osaka-shi (JP); Yoshiki Nakatani, Osaka-shi (JP); Kazuhiko Tsuda, Osaka-shi (JP)

(21) Appl. No.: 14/396,790

(22) PCT Filed: Apr. 17, 2013
(86) PCT No.: PCT/JP2013/061349

§ 371 Date: Oct. 24, 2014

(30) Foreign Application Priority Data
Apr. 24, 2012 (JP) 2012-099136

(51) Int. Cl. G02F 1/1343; G02F 1/137; G02F 1/1368

(52) U.S. Cl. CPC G02F 1/134309; G02F 1/1368; G02F 1/137; G02F 2001/134372
USPC 349/43; 349/141; 349/33; 257/43

(57) ABSTRACT

The present invention provides a liquid crystal display panel and a liquid crystal display device each having sufficiently excellent transmittance, and a thin film transistor array substrate for use in the liquid crystal display panel and the liquid crystal display device. The present invention provides a liquid crystal display panel including a first substrate, a second substrate, and a liquid crystal layer interposed between the first and second substrates, wherein the first substrate includes an electrode having a T-shaped branched section, and the electrode includes linear portions forming the T-shaped branched section and separately extending in directions different from a pixel array direction.

### TECHNICAL FIELD

The present invention relates to a liquid crystal display panel, a liquid crystal display device, and a thin film transistor array substrate. More specifically, the present invention relates to a liquid crystal display panel and a liquid crystal display device each of which includes liquid crystal molecules aligned vertically to main faces of substrates at a voltage lower than a threshold voltage and displays an image using a transverse electric field; and a thin film transistor array substrate for use in the liquid crystal display panel and the liquid crystal display device.

### BACKGROUND ART

A liquid crystal display panel has a structure in which a liquid crystal display element is interposed between a pair of glass substrates or the like. Such a liquid crystal display panel characteristically has a thin profile, a lightweight, and a low power consumption, and is indispensable in everyday life and business as a display or the like for personal computers, televisions, in-vehicle devices such as a car navigation system, and personal digital assistants such as smartphones and tablet terminals. In these applications, liquid crystal display panels of various modes have been studied in regard to the placement of electrodes and the design of the substrates for changing the optical characteristics of a liquid crystal layer.

Examples of display modes of current liquid crystal display devices include a vertical alignment (VA) mode in which liquid crystal molecules having negative anisotropy of dielectric constant are aligned vertically to the substrate surfaces; an in-plane switching (IPS) mode and a fringe field switching (FFS) mode in which a transverse electric field is applied to the liquid crystal layer to cause liquid crystal molecules having positive or negative anisotropy of dielectric constant to be aligned horizontally to the substrate surfaces; and other modes.

For examples, one document discloses, as a liquid crystal display device in the FFS-driving mode, a thin film transistor liquid crystal display having high-speed response and a wide viewing angle. The device includes a first substrate having a first common electrode layer; a second substrate having a pixel electrode layer and a second common electrode layer; a liquid crystal interposed between the first substrate and the second substrate; and a means for generating an electric field between the first common electrode layer of the first substrate and the electrode layers (i.e., the pixel electrode layer and the second common electrode layer) of the second substrate so as to provide high-speed response to a fast input-data-transfer rate and a wide viewing angle for a viewer (for example, see Patent Literature 1).

Another document discloses, as a liquid crystal device that applies a transverse electric field by multiple electrodes, a liquid crystal device including a pair of substrates disposed to face each other between which a liquid crystal layer consisting of a liquid crystal having a positive anisotropy of dielectric constant is interposed, wherein electrodes are disposed on both of the first substrate and the second substrate constituting the pair of substrates in such a manner that the electrodes face each other with the liquid crystal layer therebetween so as to apply a vertical electric field to the liquid crystal layer, and multiple electrodes for applying a transverse electric field to the liquid crystal layer are disposed on the second substrate (for example, see Patent Literature 2).

### CITATION LIST

### Patent Literature

Patent Literature 1: JP 2006-523850 T
Patent Literature 2: JP 2002-365657 A

### SUMMARY OF INVENTION

### Technical Problem

A liquid crystal display device having a vertical-alignment three-layered electrode structure (liquid crystal display device in the FFS-driving mode) achieves high-speed response by rotating liquid crystal molecules by an electric field in both rising and falling. The rising (where the display state changes from a dark state (black display) to a bright state (white display)) utilizes a fringe electric field (FFS driving) generated between an upper slit electrode and a lower planar electrode (planar electrode having no opening portions) of the lower substrate. The falling (where the display state changes from a bright state (white display) to a dark state (black display)) utilizes a vertical electric field generated by a potential difference between the substrates. At the same time, as described in Patent Literature 1, even when a fringe electric field is applied by a slit electrode to a liquid crystal display including vertically aligned liquid crystal molecules, only the liquid crystal molecules near the slit electrode ends are rotated (see FIG. 35), and thus the transmittance is insufficient.

FIG. 33 is a schematic cross-sectional view showing a liquid crystal display panel having a conventional FFS-driving three-layered electrode structure on a lower substrate. FIG. 34 is a schematic plan view showing the liquid crystal display panel shown in FIG. 33. FIG. 35 shows simulation results at the time of generation of a fringe electric field in the liquid crystal display panel shown in FIG. 33. FIG. 35 shows director D distribution, electric field distribution, and transmittance distribution. FIG. 33 shows a structure of the liquid crystal display panel in which a certain voltage is applied to a slit electrode 817 (5 V in the figure; for example, the potential difference between the slit electrode and a lower layer electrode (common electrode) 813 is at least a threshold value; the “threshold value” herein means a voltage that generates an electric field that causes optical changes in the liquid crystal layer and also changes in the display state of the liquid crystal display device). Common electrodes 813 and 823 are disposed on an array substrate 810 having the slit electrode 817 and a counter substrate 820, respectively. The common electrodes 813 and 823 are set to 0 V. FIG. 35 shows simulation results at the time of rising, showing voltage distribution, director D distribution, and transmittance distribution (solid line).

In such transverse electric field driving, the lines become dark, thus decreasing the transmittance and making it difficult to achieve high transmittance. Even if a pair of comb-shaped electrodes is used instead of the slit electrode 817, the lines still become dark, which unfortunately decreases the transmittance.

For example, the mode that switches between the vertical electric field ON state and the transverse electric field ON state provides a very high response speed, but in some cases, the transmittance is lower than that in other modes (for example, a transverse bend alignment (TBA) mode). Specifically, as described above, even in the mode that uses a pair of comb-shaped electrodes instead of the slit electrode 817 to apply a transverse electric field between the pair of comb-shaped electrodes instead of a fringe electric field so as to switch between the vertical electric field ON state and the transverse electric field ON state, only the space portions contribute to the transmittance, and the liquid crystal along the line portions remains oriented in a substantially vertical direction, resulting in dark lines. Thus, the above mode tends to have lower mode efficiency than the general modes.

The “mode efficiency” herein refers to light utilization efficiency of each display mode of the liquid crystal. The simple term “transmittance” usually refers to the efficiency determined as follows: the transmittance of polarizing plates×transmittance of color filters (CF)×aperture ratio of the panel×efficiency of the liquid crystal display mode. With the “transmittance” described above, it is difficult to isolate and clarify the transmittance loss resulting from each mode. Thus, the light utilization efficiency is determined by measuring the mode efficiency.

Usually, the mode efficiency is calculated by dividing the transmittance obtained when the polarizing plates are in a cross-Nicol state by the transmittance obtained when the polarizing plates are attached in a parallel-Nicol state to the panel (so that the terms other than the mode efficiency are cancelled).

Additionally, as shown in FIG. 36, comb-shaped electrodes 1117 and 1119 (i.e., branches) of the pair of comb-shaped electrodes extend in two separate directions, so that liquid crystal molecules LC can be tilted in four different directions, achieving a wide viewing angle.

Patent Literature 2 above discloses a liquid crystal display device having a three-layered electrode structure, wherein the response speed is increased by comb driving with comb-shaped electrodes that extend in a pixel array direction. However, Patent Literature 2 is silent about improvement in the transmittance and about the relationship between electrode structure and transmittance. In addition, substantially, it merely mentions a liquid crystal device in a twisted nematic (TN) display mode, and is silent about a vertical-alignment liquid crystal display device which is advantageous to achieve characteristics such as a wide viewing angle and high contrast.

The present invention has been made in view of the above state of the art, and aims to provide a liquid crystal display panel and a liquid crystal display device each of which includes liquid crystal molecules aligned vertically to the main faces of the substrates, for example, at a voltage lower than a threshold voltage, and displays an image using a transverse electric field; and a thin film transistor array substrate for use in the liquid crystal display panel and the liquid crystal display device, wherein the liquid crystal display panel and the liquid crystal display device have sufficiently high transmittance and the thin film transistor array substrate is used therein.

### Solution to Problem

In order to further improve the transmittance, the present inventors made further investigations on the electrode structure in the liquid crystal display panel and the liquid crystal display device each of which includes liquid crystal molecules aligned vertically to the main faces of the substrates, for example, at a voltage lower than a threshold voltage, and displays an image using a transverse electric field, and the thin film transistor array substrate for use in the liquid crystal display device and the thin film transistor array substrate; and they came to focus on the shape of an electrode of a first substrate. Then, the present inventors found that if the electrode of the first substrate was formed in a specific shape and if its edges were formed to extend in directions different from a pixel array direction, it would make it possible to reduce the ineffective region and achieve high transmittance. The present inventors found that the above problem would be successfully solved based on the above findings and thus accomplished the present invention. The present invention is particularly suitably applicable to a liquid crystal display panel and a liquid crystal display device each having a vertical-alignment three-layered electrode structure that controls the alignment of the liquid crystal molecules by an electric field in both rising and falling, because the present invention can achieve both high-speed response and high transmittance. Additionally, while the problem with the response speed is particularly notable in a low temperature environment, the liquid crystal display panel and the liquid crystal display device described above can solve the problem and achieve excellent transmittance.

The liquid crystal display panel of the present invention accomplished by the present inventors includes an improved main stem and the like in order to increase space portions as much as possible. Specifically, the shapes of the main stem and the like of the electrode (for example, indium tin oxide (ITO)) are modified as described in (1) and (2) below, thereby improving the transmittance.

(1) The electrode is configured to have a T-shaped branched section, and linear portions forming the T-shaped branched section are formed to separately extend in directions different from a pixel array direction. For example, it is preferred that a central main stem is arranged to be zigzag.

(2) The electrode is cut (provided with a slit) in the main stem and the like around the periphery of a pixel in such a manner that at least a portion of the edge of the main stem is oriented in a direction different from a pixel array direction so as to increase the space portions.

The invention according to (1) above and the invention according to (2) above reduce the ineffective region by modifying the shape of the electrode in such a manner that its edges extend in directions different from a pixel array direction to improve the transmittance. In this respect, it is considered that these inventions have common or closely-related technical significance in comparison to the prior art, and at least involve special technical features corresponding to each other.

Specifically, the present invention relates to a liquid crystal display panel (first liquid crystal display panel of the present invention) including a first substrate, a second substrate, and a liquid crystal layer interposed between the first and second substrates, wherein the first substrate includes an electrode having a T-shaped branched section, and the electrode includes linear portions forming the T-shaped branched section and separately extending in directions different from a pixel array direction.

The electrode having a T-shaped branched section may have an additional branched section having a shape other than the T shape as long as the electrode has the T-shaped branched section. For example, the electrode may have an additional branched section that allows branches to extend from the middle of the stem in a 45° oblique direction. As used herein, the term “stem” refers to a linear electrode portion from which multiple linear electrode portions (branches) branch off and extend. The term “branch” refers to a portion other than the stem, and it is a portion branched off from the stem and usually refers to a linear electrode portion that has no branches within itself. As used herein, the term “stem” is also referred to as the main stem.

The T-shaped branched section has a trifurcated structure like the letter T (block type, upper case). In other words, it suffices if the linear portions forming the T-shaped branched section extend in three directions from a branching point of the branched section in such a manner that angles of substantially 90°, substantially 90°, and substantially 180° are formed between adjacent linear portions. Preferably, the linear portions forming the T-shaped branched section extend in three directions from a branching point of the branched section in such a manner that angles of 90°, 90°, and 180° are formed between adjacent linear portions. As long as the effects of the present invention are achieved, the T-shaped branched section may include an electrode portion that extends in a direction different from the above three directions. For example, the branched section may have a cross shape. Yet, the T-shaped branched section consisting of electrode portions extending in substantially three directions is preferred. As described above, the liquid crystal display panel may include a branched section having a shape other than the T shape, in addition to the T-shaped branched section consisting of electrode portions extending in substantially three directions.

The three directions in the phrase “electrode portions extending in three directions” refer to the three directions indicated by arrows in FIG. 7, FIG. 13, FIG. 23, FIG. 27, and FIG. 29, for example. These directions will be described in detail in the later-described embodiments.

The branched section herein usually consists of a stem and branches extending from the stem.

The phrase “linear portions forming the T-shaped branched section and separately extending in directions different from a pixel array direction” herein at least means that multiple linear portions, which extend from the branching point of the branched section so as to form the T shape, extend in directions different from a pixel array direction in a plan view of the main faces of the substrates. In other words, T-shaped structures are present in at least some of bent portions of the branch electrode ends extending in first and second directions different from a pixel array direction.

The above phrase “extending in directions different from a pixel array direction” means that when pixels are arrayed in two directions (for example, a vertical direction and a transverse direction) in a plan view of a display surface to constitute the display surface, the linear portions are not parallel to either of these two directions. Preferably, in the technical field of the present invention, the linear portions form an angle of 5° or more with both of these two directions.

In the liquid crystal display panel of the present invention, preferably, the linear portions forming the T-shaped branched section of the electrode each form an angle of substantially 45° with a pixel array direction. As used herein, the phrase “each form an angle of substantially 45° with a pixel array direction” means that when pixels are arrayed in two directions (for example, a vertical direction and a transverse direction) to constitute the display surface, the linear portions form an angle of substantially 45° with either one of these two directions. More preferably, the linear portions forming the T-shaped branched section of the electrode separately form an angle of 45° with a pixel array direction.

Each electrode may include one T-shaped branched section, but usually it includes multiple T-shaped branched sections.

In the liquid crystal display panel of the present invention, the electrode of the first substrate preferably includes a zigzag stem.

In the liquid crystal display panel of the present invention, preferably, the first substrate includes a pair of comb-shaped electrodes, and at least one of the pair of comb-shaped electrodes is the electrode having the T-shaped branched section.

In addition, it is preferred that at least one of the pair of comb-shaped electrodes is formed in such a manner that its distal edge is oriented in a direction different from a pixel array direction. In particular, it is more preferred that both of the pair of comb-shaped electrodes are formed in such a manner that their distal edges are oriented in a direction different from a pixel array direction. It is still more preferred that the edges form an angle of substantially 45° with a pixel array direction.

The pair of comb-shaped electrodes is not limited as long as the two comb-shaped electrodes are arranged to face each other in a plan view of the main faces of the substrates. The pair of comb-shaped electrodes can suitably generate a transverse electric field between the comb-shaped electrodes. Thus, in the case where the liquid crystal layer includes liquid crystal molecules having a positive anisotropy of dielectric constant, the response performance and the transmittance are excellent in rising. In contrast, in the case where the liquid crystal layer includes liquid crystal molecules having a negative anisotropy of dielectric constant, the liquid crystal molecules are rotated by a transverse electric field to achieve a high response speed in falling. In addition, the electrodes of the first substrate and the second substrate are not limited as long as they can provide a potential difference between the substrates. This generates a vertical electric field by the potential difference between the substrates in falling in the case where the liquid crystal layer includes liquid crystal molecules having a positive anisotropy of dielectric constant, and in rising in the case where the liquid crystal layer includes liquid crystal molecules having a negative anisotropy of dielectric constant, and rotates the liquid crystal molecules by the electric field to achieve a high response speed.

The pair of comb-shaped electrodes may be disposed on the same layer or on different layers as long as the effects of the present invention can be achieved, but is preferably disposed on the same layer. The phrase “the pair of comb-shaped electrodes is disposed on the same layer” means that both of the comb-shaped electrodes are in contact with the same component (for example, the insulating layer, the liquid crystal layer, and the like) on the liquid crystal layer side and/or the side opposite to the liquid crystal layer side.

Preferably, the pair of comb-shaped electrodes is formed in such a manner that teeth portions (herein also referred as to “branches”) are aligned with one another in a plan view of the main faces of the substrates. In particular, preferably, the teeth portions of the pair of comb-shaped electrodes are substantially parallel to one another; in other words, each of the comb-shaped electrodes has multiple slits that are substantially parallel to one another.

According to one preferred mode of the present invention, the pair of comb-shaped electrodes can have different electric potentials at a threshold voltage or higher. The term “threshold voltage” herein refers to a voltage that provides a transmittance of 5% when the transmittance in the bright state is set to 100%, for example. The phrase “have different electric potentials at a threshold voltage or higher” herein at least means that a driving operation that generates different electric potentials at a threshold voltage or higher can be implemented. This makes it possible to suitably control the electric field applied to the liquid crystal layer. The upper limit of the different electric potentials is preferably 20 V, for example. Examples of a structure capable of providing different electric potentials include a structure in which one comb-shaped electrode of the pair of comb-shaped electrodes is driven by a TFT while the other comb-shaped electrode of the pair of comb-shaped electrodes is driven by another TFT, or the other comb-shaped electrode is allowed to communicate with a lower layer electrode disposed below the other comb-shaped electrode. This structure makes it possible to provide different electric potentials.

The present invention also relates to a liquid crystal display panel (second liquid crystal display panel of the present invention) including a first substrate, a second substrate, and a liquid crystal layer interposed between the first and second substrates, wherein the first substrate includes an electrode; at least a portion of the electrode is a linear portion extending along at least a portion of the periphery of a pixel, and the electrode includes a slit along the periphery of the pixel; and at least a portion of an edge of the slit is oriented in a direction different from a pixel array direction.

Examples of the shape of the slit include triangle, fan, and line.

In the liquid crystal display panel of the present invention, preferably, the first substrate includes a pair of comb-shaped electrodes, and at least a portion of the electrode of the first substrate is a stem of at least one of the pair of comb-shaped electrodes. In other words, the liquid crystal display panel of the present invention is a liquid crystal display panel including a first substrate, a second substrate, and a liquid crystal layer interposed between the first and second substrates, wherein the first electrode includes a pair of comb-shaped electrodes; the stem of at least one of the pair of comb-shaped electrodes is disposed along at least a portion of the periphery of a pixel and the electrode includes a slit along the periphery of the pixel; and at least a portion of an edge of the slit is oriented in a direction different from a pixel array direction.

The phrase “at least a portion of an edge of the slit is oriented in a direction different from a pixel array direction” herein at least means that at least a portion of the edge of at least one slit (cut-out portion) in the electrode of the first substrate is oriented in a direction different from a pixel array direction in a plan view of the main faces of the substrates. In particular, it is preferred that substantially the entire edge is oriented in a direction different from a pixel array direction. In addition, such a slit of the present invention is preferably applied to substantially every slit (cutout portion) provided along the periphery of the pixel of the first substrate. In the case of a fan-shaped slit having a circular edge, it is considered that substantially the entire edge is oriented in a direction different from a pixel array direction.

As described above, the above phrase “extending in directions different from a pixel array direction” means that when pixels are arrayed in two directions (for example, a vertical direction and a transverse direction) in a plan view of a display surface to constitute the display surface, the linear portions are not parallel to either of these two directions. In the technical field of the present invention, it is preferred that the linear portions are considered oblique to both of these two directions mentioned above. In addition, it is preferred that at least a portion of the edge of the slit forms an angle of substantially 45° with a pixel array direction, i.e., an angle of substantially 45° with either one of the two directions mentioned above. More preferably, an angle of 45° is formed with a pixel array direction.

Preferably, the first substrate further includes a planar electrode. The planar electrode is usually formed in such a manner that an electrical resistance layer is sandwiched between the planar electrode and a pair of com-shaped electrodes. a pair of comb-shaped electrodes and an electrical resistance layer. The planar electrode may be located above the pair of comb-shaped electrodes (viewing side) or below thereof (the side opposite to the viewing side), but is preferably located below the pair of comb-shaped electrodes (the side opposite to the viewing side).

The electrical resistance layer is preferably an insulating layer. The insulating layer may be any layer that is regarded as an insulating layer in the technical field of the present invention.

Preferably, in the liquid crystal display panel of the present invention, the first substrate includes a thin film transistor element, and the thin film transistor element includes an oxide semiconductor. The second substrate may also include a thin film transistor element.

Preferably, the liquid crystal display panel is configured in such a manner that the liquid crystal molecules in the liquid crystal layer are aligned vertically to the main faces of the substrates by an electric field generated between the first substrate and the second substrate. In addition, the electrode of the first substrate is preferably a planar electrode. Herein, the planar electrode of the first substrate is not limited as long as it has a planar shape in the region corresponding to (overlapping) the pixel, and the planar electrode may be provided with an opening portion. The term “planar electrode” herein also includes a mode in which electrode portions in multiple pixels are electrically connected. Preferred modes of the planar electrode of the first substrate include one in which electrode portions are electrically connected in all pixels, and one in which electrode portions are electrically connected along a pixel line. Preferably, the second substrate further includes a planar electrode. Preferably, the planar electrode of the second substrate has a planar shape at least at a portion overlapping the electrode of the first substrate in a plan view of the main faces of the substrates. This allows a vertical electric field to be suitably applied to achieve high-speed response. In particular, if the electrode of the first substrate is a planar electrode and the second substrate further has a planar electrode, a vertical electric field can be suitably generated by a potential difference between the substrates in falling, thus achieving high-speed response. In addition, in order to suitably apply a transverse electric field and a vertical electric field, it is particularly preferred that the electrodes (upper layer electrodes) of the second substrate on the liquid crystal layer side form a pair of comb-shaped electrodes, and the electrode (lower layer electrode) of the second substrate on the side opposite to the liquid crystal layer is a planar electrode. For example, the planar electrode of the second substrate can be provided, via an insulating layer, on a layer below the pair of comb-shaped electrodes of the second substrate (i.e., a layer opposite to the liquid crystal layer when seen from the second substrate).

The planar electrode of the first substrate and/or the second substrate is not limited as long as it has a shape that is considered planar in the technical field of the present invention. The planar electrode may have an alignment-controlling structure such as a rib or a slit in a region or may have such an alignment-controlling structure at the center portion of a pixel in a plan view of the main faces of the substrates. Yet, preferably, the planar electrode has substantially no such alignment-controlling structure.

The liquid crystal layer usually contains a component that is aligned horizontally to the main faces of the substrates at a threshold voltage or higher by an electric field generated between the pair of comb-shaped electrodes or between the first substrate and the second substrate. In particular, the liquid crystal layer preferably includes liquid crystal molecules aligned in the horizontal direction. Specifically, the liquid crystal display panel of the present invention is preferably configured in such a manner that the liquid crystal molecules in the liquid crystal layer are aligned horizontally to the main faces of the substrates by an electric field generated between the pair of comb-shaped electrodes or between the first substrate and the second substrate. For example, the liquid crystal layer preferably includes liquid crystal molecules having a positive anisotropy of dielectric constant (positive liquid crystal molecules), and is configured in such a manner that the liquid crystal molecules are aligned horizontally to the main faces of the substrates by an electric field generated by the pair of comb-shaped electrodes.

The phrase “are aligned horizontally” used herein at least means that the liquid crystal molecules are considered to be aligned horizontally in the technical field of the present invention. The liquid crystal molecules in the liquid crystal layer preferably substantially consist of liquid crystal molecules that are aligned horizontally to the main faces of the substrates at a threshold voltage or higher.

The liquid crystal layer preferably includes liquid crystal molecules having a positive anisotropy of dielectric constant (positive liquid crystal molecules). The liquid crystal molecules having a positive anisotropy of dielectric constant are aligned in a certain direction when an electric field is applied. The alignment thereof is easily controlled and such molecules can achieve a higher response speed. More preferably, the liquid crystal molecules substantially consist of liquid crystal molecules having a positive anisotropy of dielectric constant. In the case where the liquid crystal layer includes positive liquid crystal molecules, the liquid crystal molecules are horizontally aligned by a transverse electric field, and the liquid crystal molecules are vertically aligned by a vertical electric field. It is also preferred that the liquid crystal layer includes liquid crystal molecules having a negative anisotropy of dielectric constant (negative liquid crystal molecules). This can further improve the transmittance. More preferably, the liquid crystal molecules substantially consist of liquid crystal molecules having a negative anisotropy of dielectric constant. In the case where the liquid crystal layer includes negative liquid crystal molecules, the liquid crystal molecules are horizontally aligned by a transverse electric field, and the liquid crystal molecules are horizontally aligned by a vertical electric field.

In the liquid crystal display panel of the present invention, preferably, the liquid crystal layer includes the liquid crystal molecules aligned vertically to the main faces of the substrates at a voltage lower than a threshold voltage. The phrase “are aligned vertically to the main faces of the substrates” used herein at least means that the liquid crystal molecules are considered to be aligned vertically to the main faces of the substrates in the technical field of the present invention, and it includes a mode in which the liquid crystal molecules are aligned substantially vertically to the main faces of the substrates. The liquid crystal molecules in the liquid crystal layer preferably substantially consist of liquid crystal molecules that are aligned vertically to the main faces of the substrates at a voltage lower than a threshold voltage. Such a vertical-alignment liquid crystal display panel is advantageous in achieving characteristics such as a wide viewing angle and high contrast, and is used in wider applications.

At least one of the first substrate and the second substrate usually includes an alignment film on the liquid crystal layer side. The alignment film is preferably a vertical alignment film. Examples of the alignment film include alignment films formed from an organic material or an inorganic material, and photo-alignment films formed from a photoactive material. The alignment film may be an alignment film without any alignment treatment such as rubbing.

At least one of the first substrate and the second substrate preferably has a polarizing plate on the side opposite to the liquid crystal layer. The polarizing plate is preferably a circularly polarizing plate. The above structure can further improve the transmittance. The polarizing plate may also preferably be a linearly polarizing plate. The above structure can provide excellent viewing angle characteristics.

The first substrate and the second substrate included in the liquid crystal display panel of the present invention form a pair of substrates between which the liquid crystal layer is interposed. For example, the upper and lower substrates can be formed by using an insulating substrate such as glass or a resin as a base material and by forming wires, electrodes, color filters, and the like on the insulating substrate.

Preferably, at least one of the pair of comb-shaped electrodes is a pixel electrode, and the first substrate including the pair of comb-shaped electrodes is an active matrix substrate. The second substrate is preferably a color filter substrate, for example. In addition, the liquid crystal display panel of the present invention may be any of transmissive type, reflective type, and semi-transmissive type liquid crystal display panels.

The present invention further relates to a liquid crystal display device including the liquid crystal display panel of the present invention. A preferred mode of the liquid crystal display panel in the liquid crystal display device of the present invention is the same as that of the above-described liquid crystal display panel of the present invention. Examples of the liquid crystal display device include displays and the like for personal computers, televisions, in-vehicle devices such as a car navigation system, and personal digital assistants such as smartphones and tablet terminals. In particular, among liquid crystal display devices having a three-layered electrode structure in the vertical alignment mode, one in the mode that achieves high-speed response by rotating liquid crystal molecules by an electric field in both rising and falling can achieve an extremely excellent response speed, so that such a device can be suitably used as an in-vehicle liquid crystal display device such as a car navigation system which may be used in a low temperature environment, a liquid crystal display device in a field sequential display mode, a display device capable of displaying three-dimensional images, and the like.

The present invention yet further relates to a thin film transistor array substrate including a thin film transistor element for use in a liquid crystal display device, wherein the thin film transistor array substrate includes an electrode having a T-shaped branched section, and the electrode includes linear portions forming the T-shaped branched section and separately extend in directions different from a pixel array direction. The present invention still yet further relates to a thin film transistor array substrate including a thin film transistor element for use in a liquid crystal display device, wherein the thin film transistor array substrate includes an electrode, at least a portion of the electrode is a linear portion extending along at least a portion of the periphery of a pixel, and the electrode includes a slit along the periphery of the pixel; and at least a portion of an edge of the slit is oriented in a direction different from a pixel array direction.

A preferred mode of the shape and the like of the electrode of the thin film transistor array substrate of the present invention is the same as that of the above-described electrode in the liquid crystal display panel of the present invention.

The configurations of the liquid crystal display panel, the liquid crystal display device, and the thin film transistor array substrate of the present invention are not particularly limited by other components as long as these configurations essentially include such components. Other components usually used in liquid crystal display panels, liquid crystal display devices, and thin film transistor array substrates may be suitably employed.

### Advantageous Effects of Invention

The liquid crystal display panel, the liquid crystal display device, and the thin film transistor array substrate of the present invention can provide improved transmittance by the shape of the electrode of the first substrate.

### BRIEF DESCRIPTION OF DRAWINGS

FIG. 1 is a schematic cross-sectional view at the time of generation of a transverse electric field in a liquid crystal display panel according to Embodiment 1.

FIG. 2 is a schematic cross-sectional view at the time of generation of a vertical electric field in the liquid crystal display panel according to Embodiment 1.

FIG. 3 is a plan view of a pixel in the liquid crystal display panel according to Embodiment 1.

FIG. 4 is a schematic cross-sectional view of the liquid crystal display panel according to Embodiment 1.

FIG. 5 is a schematic plan view of a partially enlarged pixel of a conventional liquid crystal display panel.

FIG. 6 is a view showing a modified example of the pixel in the liquid crystal display panel shown in FIG. 5.

FIG. 7 is a schematic plan view of a partially enlarged pixel in the liquid crystal display panel according to Embodiment 1.

FIG. 8 is a schematic plan view of a partially enlarged pixel in a conventional liquid crystal display panel.

FIG. 9 is a schematic plan view of a partially enlarged pixel in the liquid crystal display panel according to Embodiment 1.

FIG. 10 is a plan view of a pixel in a liquid crystal display panel according to Embodiment 2.

FIG. 11 is a schematic cross-sectional view of the liquid crystal display panel according to Embodiment 2.

FIG. 12 is a schematic plan view of a partially enlarged pixel in a conventional liquid crystal display panel.

FIG. 13 is a schematic plan view of a partially enlarged pixel of the liquid crystal display panel according to Embodiment 2.

FIG. 14 is a further enlarged view of FIG. 13.

FIG. 15 is a schematic plan view of a pixel in a liquid crystal display panel according to a reference example.

FIG. 16 is a schematic plan view of a partially enlarged pixel in the liquid crystal display panel according to the reference example.

FIG. 17 is a schematic plan view showing an embodiment of a peripheral slit in the electrode in the liquid crystal display panel according to Embodiment 2.

FIG. 18 is a schematic plan view showing another embodiment of the peripheral slit in the electrode in the liquid crystal display panel according to Embodiment 2.

FIG. 19 is a schematic plan view showing still another embodiment of the peripheral slit in the electrode in the liquid crystal display panel according to Embodiment 2.

FIG. 20 is a schematic plan view showing still yet another embodiment of the peripheral slit in the electrode in the liquid crystal display panel according to Embodiment 2.

FIG. 21 is a schematic cross-sectional view taken along line P-Q in FIG. 20.

FIG. 22 is a plan view of a pixel in a liquid crystal display panel according to Embodiment 3.

FIG. 23 is a schematic plan view of the pixel in the liquid crystal display panel according to Embodiment 3.

FIG. 24 is a schematic cross-sectional view of the liquid crystal display panel according to Embodiment 3.

FIG. 25 is a plan view of a pixel in a liquid crystal display panel according to a modified example of Embodiment 3.

FIG. 26 is a plan view of a pixel in a liquid crystal display panel according to Embodiment 4.

FIG. 27 is a schematic plan view of a pixel in a liquid crystal display panel according to Embodiment 4.

FIG. 28 is a schematic cross-sectional view of the liquid crystal display panel according to Embodiment 4.

FIG. 29 is a schematic plan view of a pixel in a liquid crystal display panel according to Embodiment 5.

FIG. 30 is a schematic cross-sectional view of the liquid crystal display panel according to Embodiment 5.

FIG. 31 is a plan view showing a pixel of a liquid crystal display panel according to Comparative Example 1.

FIG. 32 is a schematic plan view showing a pixel of a liquid crystal display panel according to Comparative Example 2.

FIG. 33 is a schematic cross-sectional view showing a liquid crystal display panel having a three-layered electrode structure including a conventional FFS-driving electrode structure on a lower substrate.

FIG. 34 is a schematic plan view showing the liquid crystal display panel shown in FIG. 33.

FIG. 35 shows simulation results at the time of generation of a fringe electric field in the liquid crystal display panel shown in FIG. 33.

FIG. 36 is a schematic plan view showing one mode of an electrode structure and liquid crystal alignment in a pixel of a liquid crystal display panel.

FIG. 37 is a schematic cross-sectional view showing an example of a liquid crystal display panel of the present embodiment.

FIG. 38 is a schematic plan view showing an active drive element and its vicinity used in the present embodiment.

FIG. 39 is a schematic cross-sectional view showing the active drive element and its vicinity used in the present embodiment.

### DESCRIPTION OF EMBODIMENTS

The present invention will be described in more detail below referring to the drawing in the following embodiments, but is not limited to these embodiments. The term “pixel” as used herein may refer to a picture element (subpixel) unless otherwise specified. In addition, the planar electrode is not limited as long as a portion corresponding to (overlapping) the pixel is considered to have a planar shape in the technical field of the present invention. For example, the planar electrode may have an alignment-controlling structure such as a slit. Yet, preferably, the planar electrode has substantially no such alignment-controlling structure. Of the pair of substrates between which the liquid crystal layer is interposed, the substrate on the display surface side is also referred to as an upper substrate, and the substrate on the side opposite to the display surface is also referred to as a lower substrate. In addition, of the electrodes disposed on the substrates, the electrodes on the display surface side are also referred to as upper layer electrodes, and the electrode on the side opposite to the display surface is also referred to as a lower layer electrode. In addition, a circuit substrate (first substrate) of the present embodiment is also referred to as a TFT substrate or an array substrate because it includes a thin film transistor element (TFT). In Embodiments 1 to 4 among the present embodiments, a voltage is applied to the pixel electrode (for example, at least one electrode of the pair of comb-shaped electrodes) by turning the TFTs to the ON state in both rising (for example, application of a transverse electric field) and falling (for example, application of a vertical electric field). In Embodiment 1, first, the mode that switches between the vertical electric field ON state and the transverse electric field ON state will be described in detail.

It should be noted that the components and parts having the same functions are indicated by the same signs in the embodiments. In addition, unless otherwise stated, in the drawing, the symbol (i) indicates an electric potential of one of the comb-shaped electrodes on the upper layer of the lower substrate; the symbol (ii) indicates an electric potential of other comb-shaped electrode on the upper layer of the lower substrate; the symbol (iii) indicates an electric potential of the planar electrode on the lower layer of the lower substrate; and the symbol (iv) indicates an electric potential of the planar electrode of the upper substrate. The reference numbers indicate the same components if the one's and ten's digits remain the same while the hundred's and thousand's digits are changed, unless otherwise stated.

### Embodiment 1

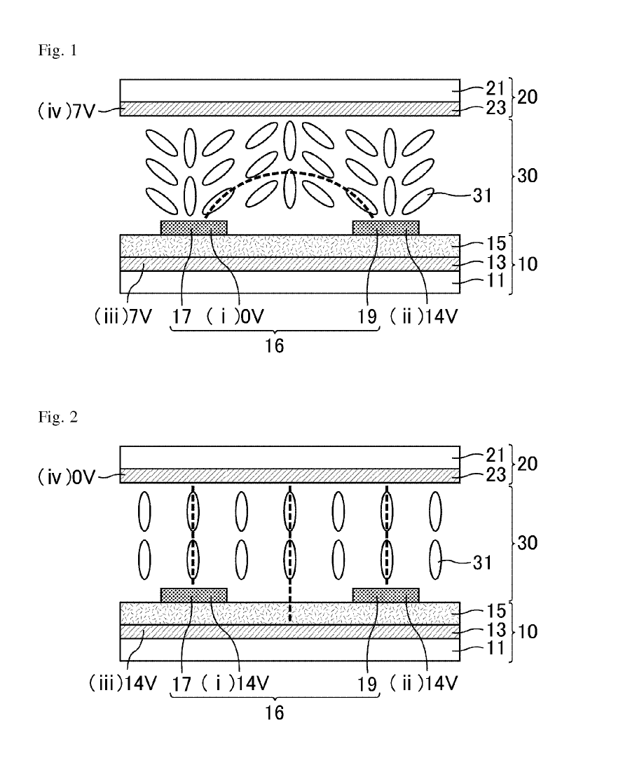

FIG. 1 is a schematic cross-sectional view at the time of generation of a transverse electric field in a liquid crystal display panel according to Embodiment 1. FIG. 2 is a schematic cross-sectional view at the time of generation of a vertical electric field in the liquid crystal display panel according to Embodiment 1. In FIG. 1 and FIG. 2, the dashed lines indicate the direction of the electric field generated. The liquid crystal display panel according to Embodiment 1 has a three-layered electrode structure in the vertical alignment mode in which liquid crystal molecules 31 (i.e., a positive liquid crystal) are used (herein, upper electrodes of the lower substrate, which serve as the second layer, form a pair of comb-shaped electrodes). In rising, as shown in FIG. 1, the liquid crystal molecules are rotated by a transverse electric field generated by a potential difference of 14 V between a pair of comb-shaped electrodes 16 (for example, it consists of a comb-shaped electrode 17 having an electric potential of 0 V and a comb-shaped electrode 19 having an electric potential of 14V). At this time, substantially no potential difference is generated between the substrates (between a lower layer electrode (common electrode) 13 having an electric potential of 7 V and a common electrode 23 having an electric potential of 7 V).

In falling, as shown in FIG. 2, the liquid crystal molecules are rotated by a vertical electric field generated by a potential difference of 14 V generated between the substrates (for example, between the electrodes (such as the lower layer electrode (common electrode) 13, the comb-shaped electrode 17, and the comb-shaped electrode 19 each having an electric potential of 14 V) and the common electrode 23 having an electric potential of 0 V). At this time, substantially no potential difference is generated between the pair of comb-shaped electrodes 16 (for example, it consists of the comb-shaped electrode 17 having an electric potential of 14 V and the comb-shaped electrode 19 having an electric potential of 14 V).

In Embodiment 1, high-speed response is achieved by rotating the liquid crystal molecules by an electric field in both rising and falling. Specifically, the transverse electric field between the pair of comb-shaped electrodes leads to the ON state to achieve high transmittance in rising, whereas the vertical electric field between the substrates leads to the ON state to achieve a high response speed in falling. Further, the transverse electric field by comb driving can rotate the liquid crystal molecules across a wider range between the pair of comb-shaped electrodes. This can achieve high transmittance, compared to the case where the driving is provided only by a fringe electric field. In Embodiment 1 and subsequent embodiments, a positive liquid crystal is used as a liquid crystal. Yet, a negative liquid crystal may be used instead of a positive liquid crystal. In the case where a negative liquid crystal is used, the liquid crystal molecules will be aligned horizontally by a potential difference between the pair of substrates, and the liquid crystal molecules will be aligned horizontally by a potential difference between the pair of comb-shaped electrodes. This results in excellent transmittance, and achieves high-speed response by rotating the liquid crystal molecules by the electric fields in both rising and falling.

As shown in FIG. 1 and FIG. 2, the liquid crystal display panel according to Embodiment 1 includes an array substrate 10, a liquid crystal layer 30, and a counter substrate 20 (color filter substrate) stacked in the stated order from the back side to the viewing side of the liquid crystal display panel. The liquid crystal display panel of Embodiment 1 vertically aligns the liquid crystal molecules when the voltage difference between the pair of comb-shaped electrodes is lower than a threshold voltage. In addition, as shown in FIG. 1, an electric field generated between the upper electrodes 17 and 19 (the pair of comb-shaped electrodes 16) formed on a glass substrate 11 (first substrate) tilts the liquid crystal molecules in the horizontal direction between the comb-shaped electrodes when the voltage difference between the comb-shaped electrodes is equal to or higher than the threshold voltage, thereby controlling the amount of light transmitted. The planar lower layer electrode 13 (the common electrode 13) is formed in such a manner that an insulating layer 15 is sandwiched between the lower layer electrode 13 and the upper layer electrodes 17 and 19 (the pair of comb-shaped electrodes 16). The insulating layer 15 is formed from, for example, an oxide film (SiO₂), a nitride film (SiN), or an acrylic resin. These materials can be used in combination.

Although not shown in FIG. 1 and FIG. 2, a polarizing plate is disposed on each substrate on the side opposite to the liquid crystal layer. The polarizing plate may be either a circularly polarizing plate or a linearly polarizing plate. An alignment film is disposed on the liquid crystal layer side of the each substrate. The alignment film is preferably a vertical alignment film that aligns the liquid crystal molecules vertically to the film surface. The alignment film may be either an organic alignment film or an inorganic alignment film.

A voltage supplied from an image signal line is applied to the comb-shaped electrode 19, which drives the liquid crystal material, through a thin film transistor element (TFT) at the timing when the pixel is selected by a scanning signal line. In the present embodiment, the comb-shaped electrode 17 and the comb-shaped electrode 19 are formed on the same layer, and the mode in which these electrodes are formed on the same layer is preferred. Yet, these electrodes may be formed on different layers as long as a voltage difference is generated between the comb-shaped electrodes to apply a transverse electric field, thereby achieving the effect of the present invention to improve the transmittance. The comb-shaped electrode 19 is connected to a drain electrode that extends from the TFT through a contact hole. The voltage can be set in accordance with the gray scale. Instead of or similar to the comb-shaped electrode 19, the comb-shaped electrode 17 may be connected to a drain electrode that extends from the TFT through a contact hole. In addition, in FIG. 1 and FIG. 2, the common electrodes 13 and 23 each have a planar shape, and for example, the common electrodes 13 may consist of electrodes that are commonly connected along even-numbered lines of the gate bus lines and electrodes that are commonly connected along odd-numbered lines of the gate bus lines. Herein, such an electrode is also referred to as a planar electrode as long as a portion corresponding to (overlapping) the pixel has a planar shape. The common electrode 23 is commonly connected to all pixels.

The characteristic shape of the electrode of the present invention will be described in detail below.

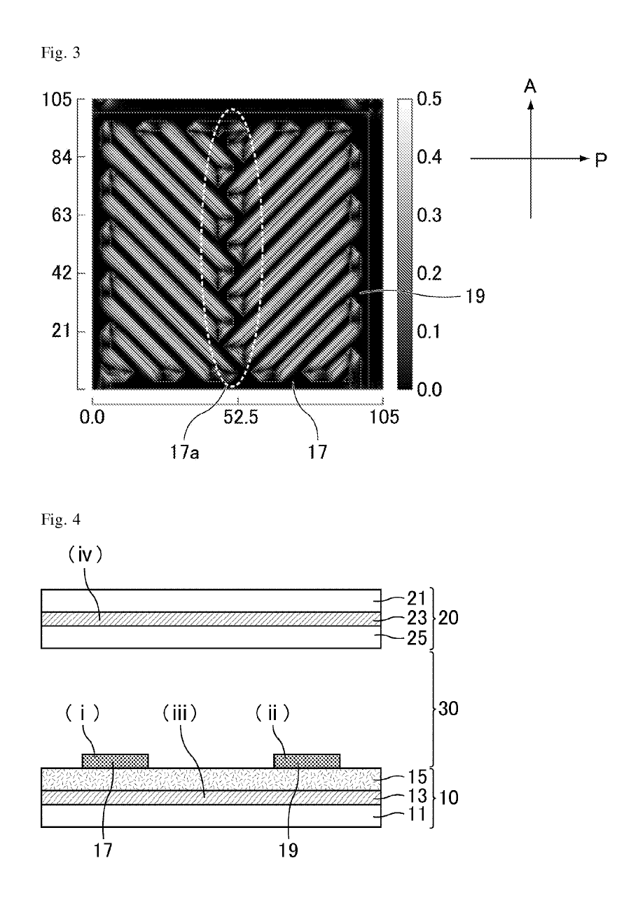

FIG. 3 is a plan view of a pixel in the liquid crystal display panel according to Embodiment 1. In FIG. 3, the values (0.0, 0.1, 0.2, 0.3, 0.4, and 0.5) corresponding to color shades shown on the right side indicate the mode efficiency of each shaded portion in the picture (a lighter and whiter color indicates a higher mode efficiency). The transmittance is 12%. The term “transmittance” herein refers to a value of polarizing plate transmittance×mode efficiency (for simplification, the aperture ratio and the transmittance of color filters (CFs) are not considered in simulation) relative to 100% transmittance that corresponds to a state without any components in the technical field of the present invention.

In FIG. 3, the axes shown on the lower side and the left side indicate the position (the unit is μm). In addition, the arrow pointing to “A” indicates the direction of an analyzer in the liquid crystal display panel, and the arrow pointing to “P” indicates the direction of a polarizer. The same applies to the figures described later. The liquid crystal display panel of the present embodiment uses an easily available polarizing plate that can be disposed in such a manner that the analyzer and the polarizer are oriented at an angle of 0° or 90° relative to a pixel array direction. Such a polarizing plate is preferred.

In Embodiment 1, the main stem at the center of the electrode is designed to be zigzag. In Embodiment 1, the connection mode between the stem and the branch of the comb-shaped electrode (a portion 17a surrounded by the white dashed line) is obtained by changing the corresponding part in Comparative Example 1 described below. The modified mode will be described in detail below. This can reduce the area of the ineffective region and thus improve the transmittance.

The pair of comb-shaped electrodes of the first substrate consists of the comb-shaped electrode 17 having a protrusion-shaped stem and the comb-shaped electrode 19 having a recess-shaped stem. The comb-shaped electrode 17 of the first substrate has a protrusion-shaped stem, and branches extend from bending points in the zigzag stem in a direction of one of extended lines of segments forming the bending points in the stem. The branches are arranged so as to project alternately to the left and right. In addition, the comb-shaped electrode 19 of the first substrate has a recess-shaped stem, and branches extend from the stem toward the center portion of the pixel. In Embodiment 1, the pixels are arranged line-symmetrically, so that the viewing angle tends to be the same in any direction.

It may be such that a comb-shaped electrode having an upward stem as in the comb-shaped electrode 17 shown in FIG. 3 is a gray scale electrode whose voltage can be set in accordance with the gray scale, and that a comb-shaped electrode having a recess-shaped stem as in the comb-shaped electrode 19 is a reference electrode whose voltage is not fixed in accordance with the gray scale but is basically fixed to serve as a reference for the gray scale electrode. Alternatively, it may be such that a comb-shaped electrode having a protrusion-shaped stem is a reference electrode and a comb-shaped electrode having a recess-shaped stem is a gray scale electrode.

The stem forming the protrusion-shaped structure extends substantially in the same direction as a pixel array direction. The phrase “the stem extends in the same direction as a pixel array direction” means that the stem extends in either a vertical or horizontal direction of the pixel. The stem (main stem) forming the protrusion-shaped structure does not have to be linear. For example, the main stem may be zigzag as long as the main stem is considered to form a protrusion-shaped structure as a whole.

In the present embodiment, the comb-shaped electrode has an electrode width L of 3 μm. The electrode width L is preferably 2 μm or more, for example. The comb-shaped electrode has an inter-electrode space S of 3 μm. The inter-electrode space S is preferably 2 μm or more, for example. The upper limits of the electrode width L and the inter-electrode space S are both 7 μm, for example.

The ratio (L/S) between the inter-electrode space S and the electrode width L is preferably 0.4 to 3, for example. The lower limit is more preferably 0.5, and the upper limit is more preferably 1.5.

A cell gap d is set to 3.7 μm, yet it may be any value in a range of 2 μm to 7 μm. A value in the above range is preferred. The cell gap d (the thickness of the liquid crystal layer) herein is preferably calculated by averaging the thicknesses throughout the liquid crystal layer in the liquid crystal display panel.

### Verification of Transmittance by Simulation in Embodiment 1

FIG. 4 is a schematic cross-sectional view of the liquid crystal display panel according to Embodiment 1. Simulation was performed in accordance with the conditions of the calculation example below.

### (Calculation Example)

Pixel size=100 μm×100 μm

Line/Space=3 μm/3 μm

Main stem (stem) width=3 μm

OC (overcoat) layer thickness=1.5 μm, dielectric constant ∈=3.8

Cell gap=3.7 μm

Insulating layer (PASS) thickness=0.3 μm, dielectric constant ∈=6.9

### Applied Voltage

### (i) 7.5 V

### (ii) 0 V

(iii) 4 V

### (iv) 0 V

The calculation was performed using Expert LCD (trade name available from NTT Advanced Technology Corporation).

The ratio of transmittance of the liquid crystal display panel of Embodiment 1 to that of Comparative Example 1 (described later) was 105%.

### Explanation for Modification in Embodiment 1 from Prior Art

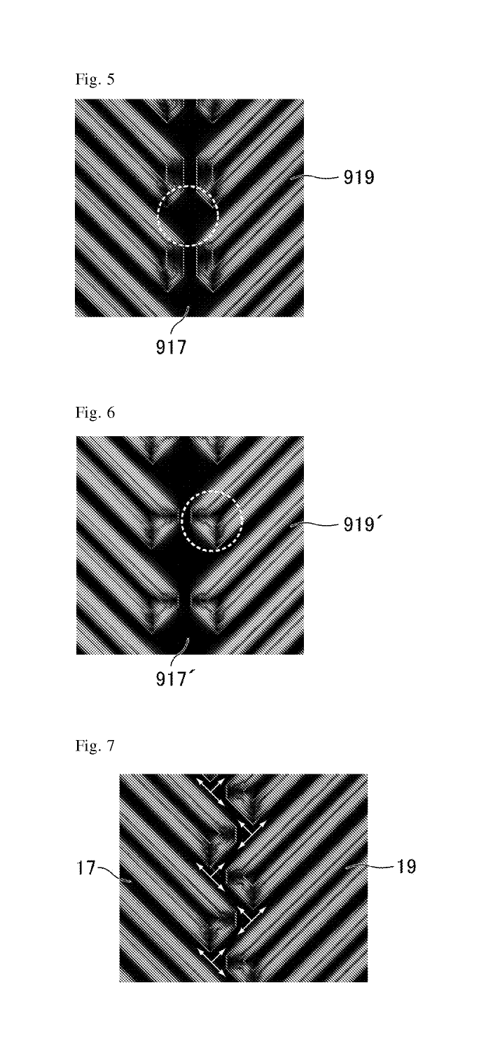

FIG. 5 is a schematic plan view of a partially enlarged pixel of a conventional liquid crystal display panel. In FIG. 5, a portion (ineffective region) surrounded by the white dashed line is eliminated. First, an edge portion of a comb-shaped electrode 919′ (a portion surrounded by the white dashed line in FIG. 6) is obliquely cut at angle of 45 degrees to a pixel array direction to make it parallel to the line (FIG. 6, which is a view showing a modified example of the pixel in the liquid crystal display panel shown in FIG. 5). Further, to make the T-shaped branched section of the comb-shaped electrode 17, the linear portions forming the T-shaped branched section are arranged so as to separately extend in directions (directions indicated by white arrows in FIG. 7) different from pixel array directions (vertical and horizontal directions in FIG. 7). Here, the left and right comb-shaped electrodes 19 are alternately arranged (FIG. 7, which is a schematic plan view of a partially enlarged pixel in the liquid crystal display panel according to Embodiment 1). The above configuration can eliminate the ineffective region and expand the transmission region, thus improving the transmittance as described above.

### Additional Explanation to Embodiment 1

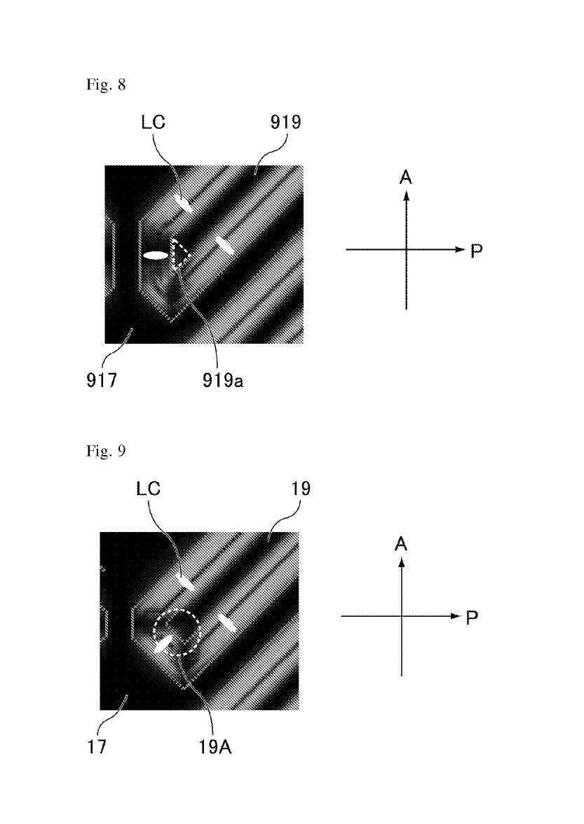

FIG. 8 is a schematic plan view of a partially enlarged pixel in a conventional liquid crystal display panel. The region in which the liquid crystal molecules LC are horizontally oriented in FIG. 8 is dark because the liquid crystal LC is tilted in the axial direction of the polarizing plate (direction of polarizer). Here, a triangular portion 919a surrounded by the white dashed line is cut and modified as shown in a portion surrounded by the white dashed line in FIG. 9 (FIG. 9 is a schematic plan view of a partially enlarged pixel in the liquid crystal display panel according to Embodiment 1). As a result, this improves the transmittance.

### Embodiment 2

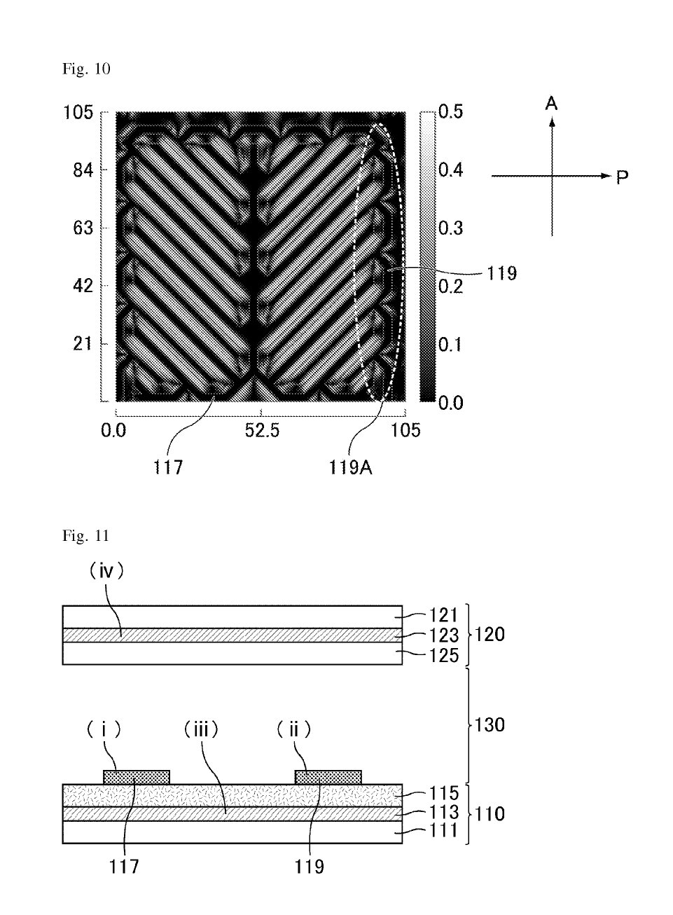

FIG. 10 is a plan view of a pixel in a liquid crystal display panel according to Embodiment 2. In Embodiment 2, a main stem at the peripheral of the electrode includes slits. In Embodiment 2, the main stem at the peripheral of the electrode (portion surrounded by the white dashed line) is obtained by modifying the corresponding part in Comparative Example 1 (described later). The modification mode will be described in further detail below. This can reduce the area of the ineffective region and thus improve the transmittance.

In Embodiment 2, the main stem is provided with a triangular-shaped cut while maintaining at least the minimum line width of the main stem, whereby the transmittance can be improved. As described above, a structure is preferred in which the width of the linear electrode portion of the main stem provided with the space is not less than the line width of other main stems. For example, it is preferred that the width of the linear electrode portion of the main stem provided with the space is substantially equal to the width of other linear electrode portions.

The pair of comb-shaped electrodes of the first substrate includes a comb-shaped electrode 117 having a protrusion-shaped stem and a comb-shaped electrode 119 having a recess-shaped stem. The comb-shaped electrode 117 of the first substrate has a protrusion-shaped stem, and branches extend in upper right and upper left directions from each point of the stem running through the center of the pixel. In addition, the comb-shaped electrode 119 of the first substrate has a recess-shaped stem, and branches extend in lower right and lower left directions from the stem toward the stems running through the center of the pixel. Both comb-shaped electrodes are arranged to face each other. In addition, the branches of these comb-shaped electrodes are aligned with one another.

The stem forming the protrusion-shaped structure extends substantially in the same direction as a pixel array direction. The phrase “the stem extends in the same direction as a pixel array direction” means that the stem extends in either a vertical or horizontal direction of the pixel in the case where the pixels are arrayed in vertical and horizontal directions. Here, the stem (main stem) forming the protrusion-shaped structure does not have to be linear. For example, the main stem may be zigzag as shown in Embodiment 3 (described later) as long as the main stem is considered to form a protrusion-shaped structure as a whole.

### Verification of Transmittance by Simulation in Embodiment 2

FIG. 11 is a schematic cross-sectional view of the liquid crystal display panel according to Embodiment 2. Simulation was performed using Expert LCD (trade name available from NTT Advanced Technology Corporation) under the same conditions for the calculation example in Embodiment 1. The ratio of transmittance of the liquid crystal display panel of Embodiment 2 to that of Comparative Example 1 (described later) was 104%.

### Explanation for Modification in Embodiment 2 from Prior Art

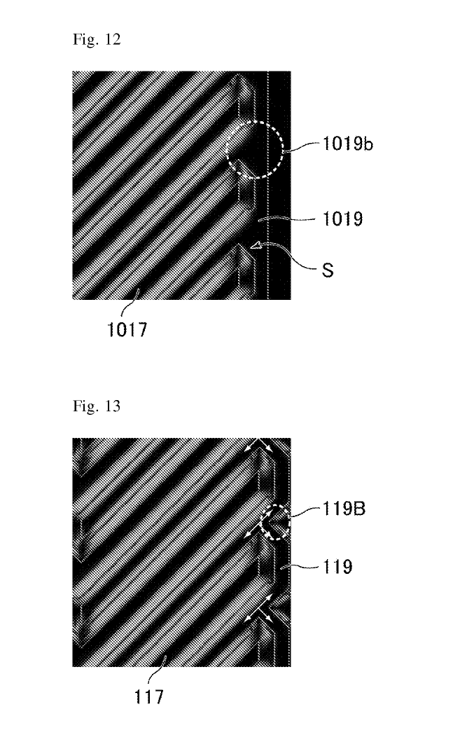

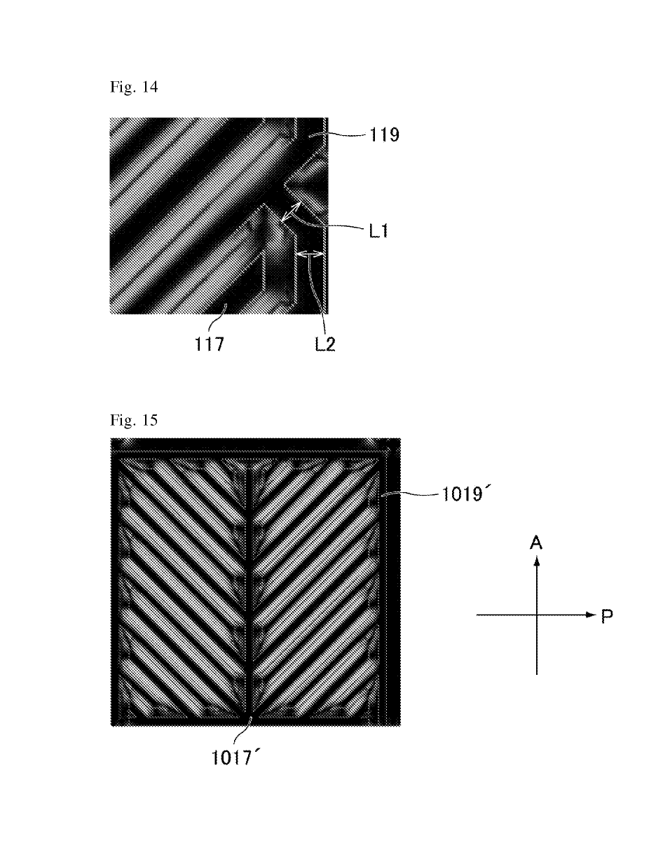

FIG. 12 is a schematic plan view of a partially enlarged pixel in a conventional liquid crystal display panel. In FIG. 12, a portion 1019b surrounded by the white dashed line, which is an ineffective region that does not contribute to the transmittance, is eliminated. Specifically, for example, a triangular-shaped cut is made as in a portion 119B surrounded by the white dashed line, thereby making contributions to the transmittance (FIG. 13, which is a schematic plan view of a partially enlarged pixel of the liquid crystal display panel according to Embodiment 2). FIG. 14 is a further enlarged view of FIG. 13. There is no design problem as long as it is designed such that an electrode width L1 after a cut is made is equal to or larger than a main stem width L2 of another electrode portion as shown in FIG. 13.

### Additional Explanation to Embodiment 2

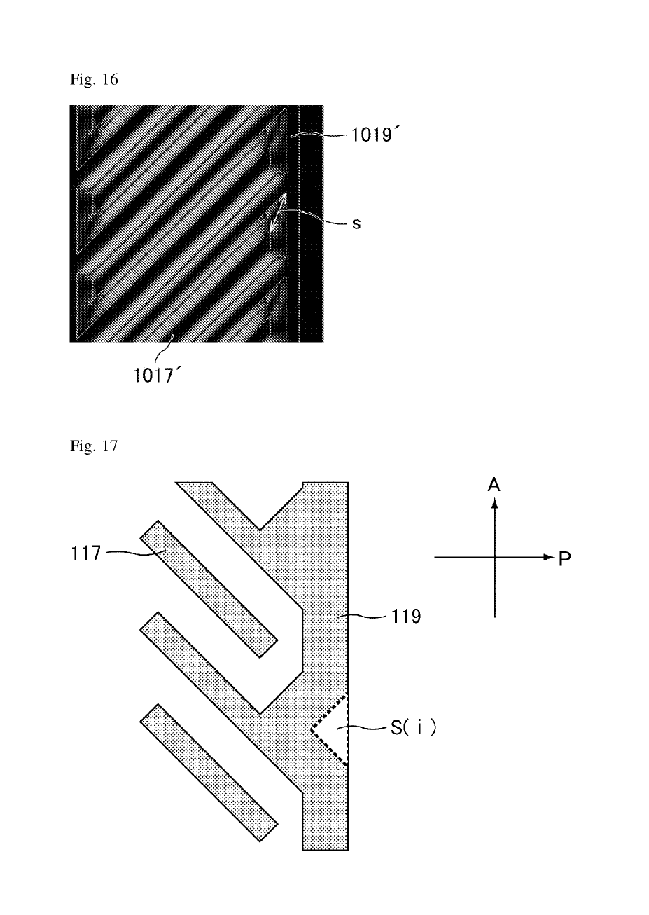

FIG. 15 is a schematic plan view of a pixel in a liquid crystal display panel according to a reference example. FIG. 16 is a schematic plan view of a partially enlarged pixel in the liquid crystal display panel according to the reference example. A portion “s” indicated by the double-headed arrow in FIG. 16 does not contribute to the transmittance because the space width is wide. Thus, as shown in FIG. 12, the space portion is partially cut (see a portion “S” showing an example of the cut in FIG. 12; the same applies to FIG. 13 according to Embodiment 2).

### <Shape of Peripheral Slit>

FIG. 17 to FIG. 19 are each a schematic plan view showing an embodiment of a peripheral slit in the electrode in the liquid crystal display panel according to Embodiment 2. The shape of the peripheral slit may be any shape as long as the effects of the present invention can be achieved. Preferred examples of the shape include triangle, fan, and line (linear shape), which are described in detail below.

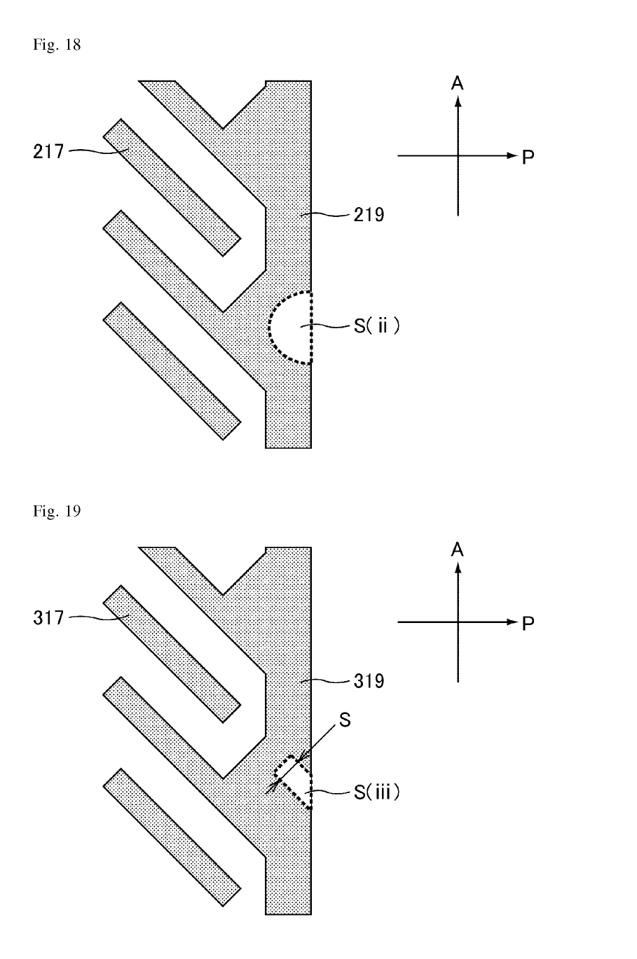

For example, in the case where the shape of the peripheral slit is a triangle, the slit S(i) (triangular portion) can be most effectively used (FIG. 17). In addition, the corner will be rounded after etching, so that a slit S (ii) having a fan shape may be made. This can also sufficiently achieve the effect of the present invention to improve the transmittance (FIG. 18). Further, in the case where the shape of the peripheral slit is a line, the width S of a slit S (iii) is constant because of the line shape. Thus, the liquid crystal is easily tilted, which can improve the transmittance.

In FIG. 17 to FIG. 19, the comb-shaped electrodes 117, 217, and 317 each have a distal end that is oriented at 45° to a pixel array direction. In other words, the distal end forms an angle of 45° with both of the orientation A of the analyzer and the orientation P of the polarizer. The above is a preferred mode. Yet, as shown in FIG. 10, the edge may be oriented in the vertical direction (same direction as a pixel array direction).

Even if the shape of an electrode portion provided with a slit along the periphery of the pixel is not T-shaped, the effect of the present invention to improve the transmittance can be achieved as long as at least a portion of the edge of the slit in the electrode formed along the periphery is oriented in a direction different from a pixel array direction. It is more preferred that substantially the entire edge of the slit in the electrode formed along the periphery is oriented in a direction different from a pixel array direction. In the present embodiment, substantially the entire edge of the slit in the electrode formed along the periphery forms an angle of 45° with a pixel array direction. In each of FIG. 17 to FIG. 19, the electrode includes one slit, but the electrode may include multiple slits. For example, it is preferred that a slit is formed in each branched section (cross portion) in the main stem of the electrode.

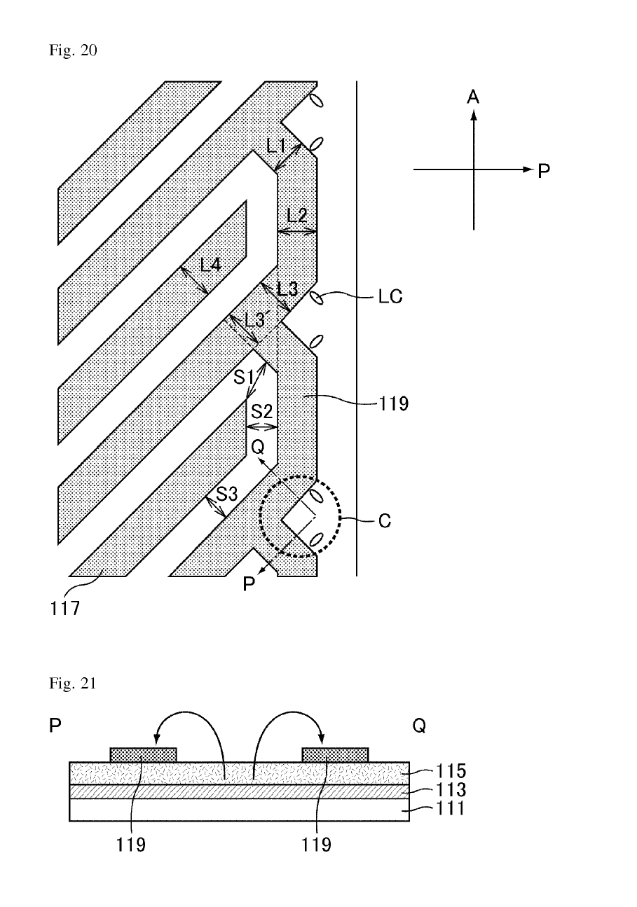

FIG. 20 is a schematic plan view showing an embodiment of a peripheral slit in the electrode in the liquid crystal display panel according to Embodiment 2. FIG. 21 is a schematic cross-sectional view taken along line P-Q in FIG. 20. Owing to a peripheral slit, the transmittance can be improved at the peripheral slit portion when the liquid crystal molecules are aligned by a fringe electric field shown in FIG. 21.

In FIG. 20, it is preferred that the electrode width is substantially the same at all portions (L1=L2=L3=L3′=L4). If the main stem is provided with a triangular cut while maintaining at least the minimum line width L1 (=L2) of the main stem, the width L3 of the main stem provided with a cut can be adjusted to the same electrode width at other portions. In addition, it is preferred that the space width is also substantially the same at all portions (S1=S2=S3). FIG. 20 shows a peripheral slit having a triangular shape. Yet, even if the peripheral slit has a fan shape or a line shape, it is similarly preferred that the electrode width is substantially the same at all portions and that the space width is substantially the same at all portions.

In Embodiment 2, the electrodes of the first substrate having the characteristics of the present invention form the pair of comb-shaped electrodes. Yet, instead of the pair of comb-shaped electrodes, one electrode used in a liquid crystal display device in the FFS mode (for example, a slit electrode having inwardly formed slits in a plan view of the main faces of the substrates) maybe used as the first substrate, and slits as described above may be further provided along the periphery of the electrode. Such a configuration can also achieve the effect of the present invention to improve the transmittance. When one electrode is used instead of the pair of comb-shaped electrodes, such a configuration can be suitably employed in a liquid crystal display device in the FFS mode, for example. Other configurations of the Embodiment 2 are the same as those of the Embodiment 1 described above.

### Embodiment 3

FIG. 22 is a plan view of a pixel in a liquid crystal display panel according to Embodiment 3. In Embodiment 3, the main stem at the center of the electrode is designed to be zigzag and the main stem at the periphery of the electrode includes slits.

In Embodiment 3, the main stem at the center of the electrode and the main stem at the peripheral of the electrode are obtained by modifying the corresponding parts in Comparative Example 1 (described later) in the same manner as in Embodiments 1 and 2 described above. This can reduce the area of the ineffective region and thus achieve a significant effect to improve the transmittance.

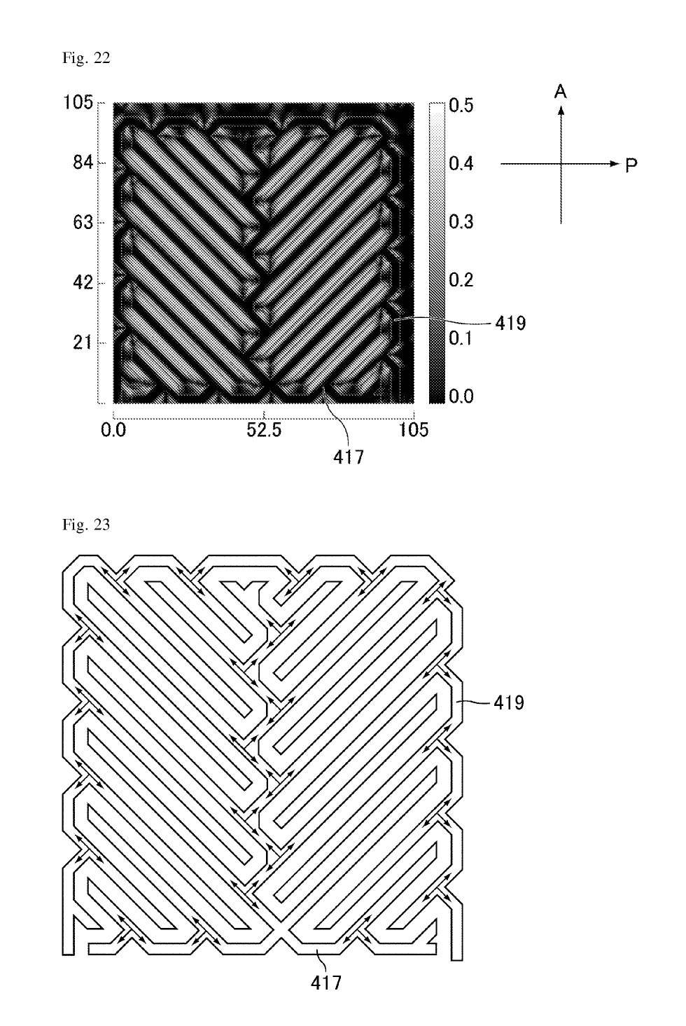

FIG. 23 is a schematic plan view of the pixel in the liquid crystal display panel according to Embodiment 3. In FIG. 23, as indicated by the arrows, the linear portions forming the T-shaped branched section separately extend in directions different from a pixel array direction. Specifically, the linear portions extend in directions different from both of the orientation A of the analyzer and the orientation P of the polarizer.

### Verification of Transmittance by Simulation in Embodiment 3

FIG. 24 is a schematic cross-sectional view of the liquid crystal display panel according to Embodiment 3. Simulation was performed using Expert LCD (trade name available from NTT Advanced Technology Corporation) under the same conditions for the calculation example in Embodiment 1. The ratio of transmittance of the liquid crystal display panel of Embodiment 3 to that of Comparative Example 1 (described later) was 109%.

Other configurations of the Embodiment 3 are the same as those of the Embodiment 1 described above.

### (Modified Example of Embodiment 3)

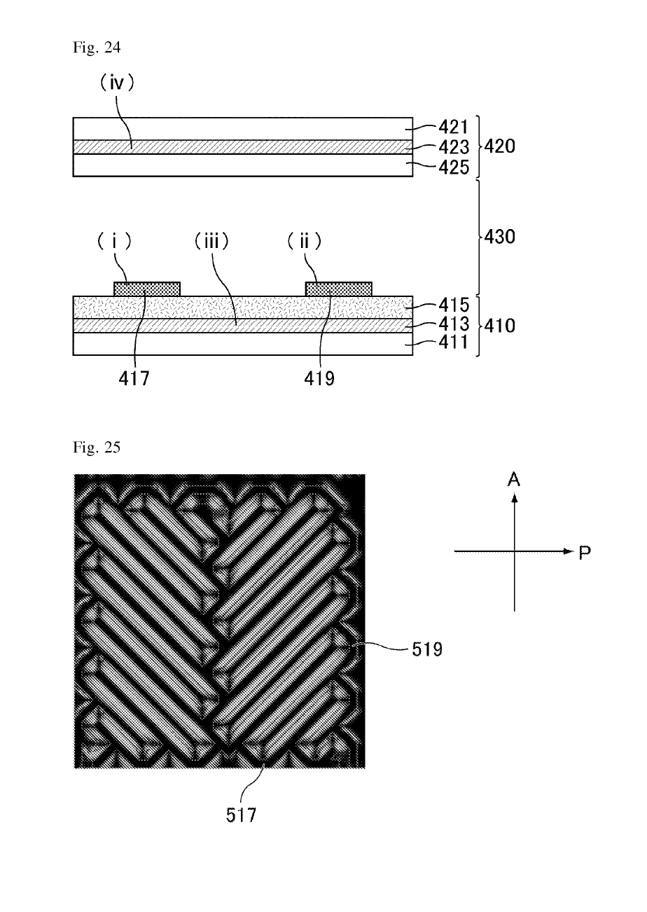

FIG. 25 is a plan view of a pixel in a liquid crystal display panel according to a modified example of Embodiment 3. In the modified example of Embodiment 3, the main stem at the center of the electrode and the main stem at the peripheral of the electrode are modified from those of Comparative Example 1 (described later) in the same manner as in Embodiments 1 and 2 described above.

Further, a peripheral edge portion (distal edge portion) of a comb-shaped electrode 517 is also tilted at 45 degrees. Specifically, the distal end of the comb-shaped electrode 517 is tilted at 45° to a pixel array direction. In other words, the distal end forms an angle of 45° with both of the orientation A of the analyzer and the orientation P of the polarizer. Providing slits in the ineffective region in the above configuration results in higher luminance.

Simulation was performed using Expert LCD (trade name available from NTT Advanced Technology Corporation) under the same conditions for the calculation example in Embodiment 1. The ratio of transmittance of the liquid crystal display panel of the modified example of Embodiment 3 to that of Comparative Example 1 was 110%.

Other configurations of the modified example of Embodiment 3 are the same as those of the Embodiment 3 described above.

### Embodiment 4

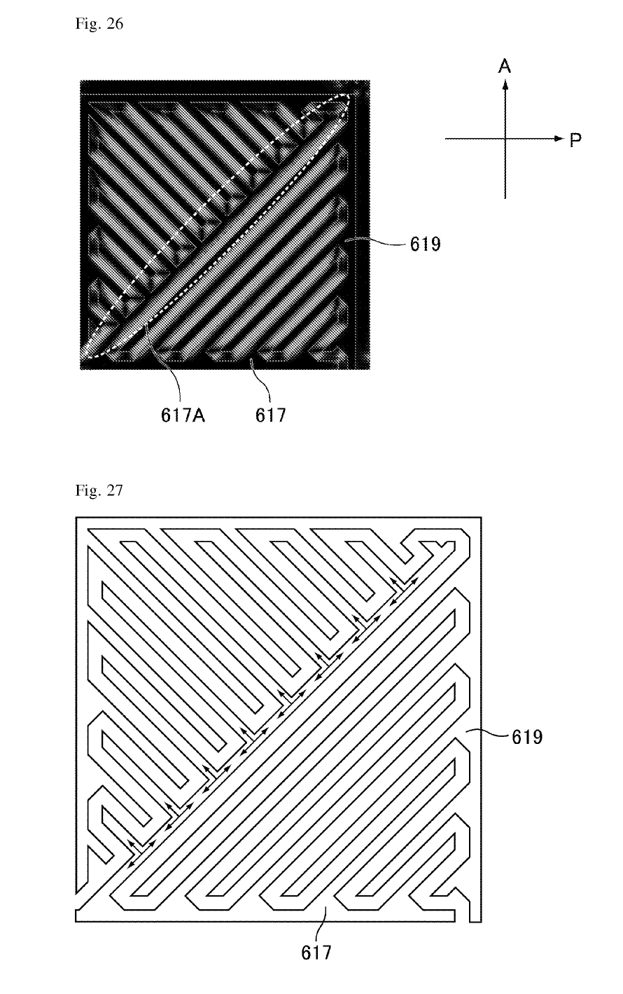

FIG. 26 is a plan view of a pixel in a liquid crystal display panel according to Embodiment 4.

In Embodiment 4, the main stem at the center of a comb-shaped electrode 617 in a portion 617A surrounded by the white dashed line is obtained by modifying the corresponding part in Comparative Example 1 (described later) in such a manner that the main stem is tilted. The main stem at the center is tilted at 45 degrees. Specifically, the comb-shaped electrode 617 is configured in such a manner that its main stem running through the center of the pixel is tilted at 45° to a pixel array direction. In other words, the main stem forms an angle of 45° with both of the orientation A of the analyzer and the orientation P of the polarizer. This can reduce the ineffective region that does not contribute to the transmittance.

FIG. 27 is a schematic plan view of a pixel in a liquid crystal display panel according to Embodiment 4. In FIG. 27, as indicated by the arrows, the linear portions forming the T-shaped branched section separately extend in directions that form an angle of 45° with a pixel array direction.

In Embodiment 4, the main stem is longer than that in Embodiment 1 and the like. Thus, Embodiment 1 achieves better yield than Embodiment 4.

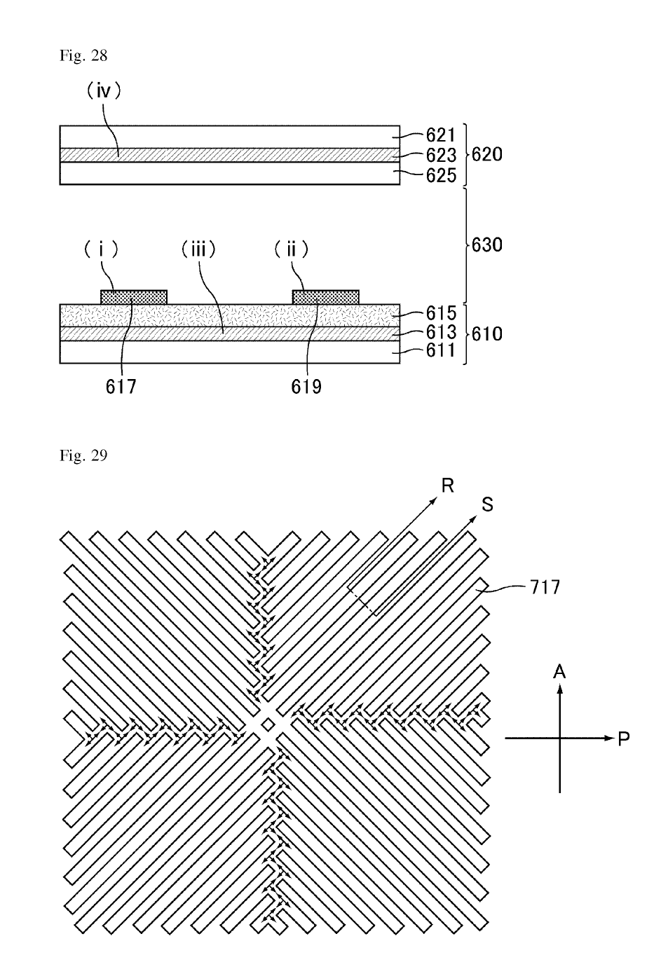

FIG. 28 is a schematic cross-sectional view of the liquid crystal display panel according to Embodiment 4. Simulation was performed using Expert LCD (trade name available from NTT Advanced Technology Corporation) under the same conditions for the calculation example in Embodiment 1. The ratio of transmittance of the liquid crystal display panel of Embodiment 4 to that of Comparative Example 1 was 105%.

Other configurations of the Embodiment 4 are the same as those of the Embodiment 3 described above.

One embodiment of the above-described liquid crystal display panel having a three-layered electrode structure may include three TFTs per pixel. Another embodiment may be configured in such a manner that the electrodes are shared between the pixels for each line or are electrically connected via contact holes in the pixels, and include two TFTs per pixel or one TFT per pixel.

The main lines of the electrodes (ITO, IZO, or the like) electrically connected along the pixel lines preferably overlap a metal line in a plan view of the main faces of the substrates. Because the metal line usually does not allow transmission of light therethrough, arranging the main lines of the electrically connected electrodes along the pixel lines as described above can increase the aperture ratio. Preferably, the metal line is at least one selected from the group consisting of a source bus line, a gate bus line, and a metal line for reducing the capacitance.

### Embodiment 5

FIG. 29 is a schematic plan view of a pixel in a liquid crystal display panel according to Embodiment 5.

An electrode of Embodiment 5 is a fishbone-shaped electrode. A fishbone-shaped electrode 717 is obtained by modifying a fishbone-shaped electrode shown in Comparative Example 2 (described below), and has a T-shaped branched section. The linear portions forming the T-shaped branched section separately extend in directions different from pixel array directions (vertical and horizontal directions in FIG. 29). Specifically, the linear portions form an angle of 45° with both of the orientation A of the analyzer and the orientation P of the polarizer. The above configuration can eliminate the ineffective region and expand the transmission region, thus improving the transmittance as described above.

Herein, it is preferred to divide the fishbone structure into four sections in order to tilt the liquid crystal molecules in four directions. Usually, the fishbone structure is divided into four sections as shown in FIG. 29.

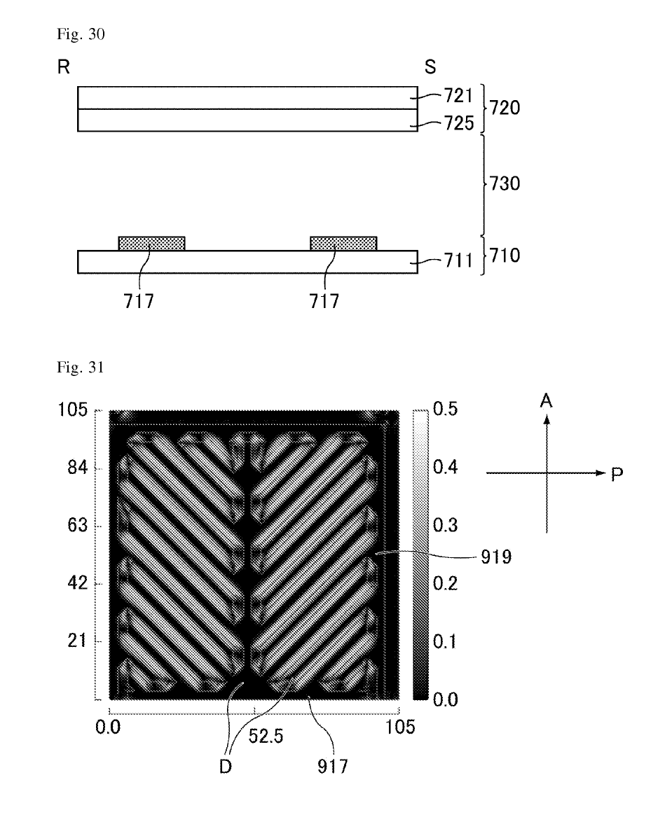

FIG. 30 is a schematic cross-sectional view of the liquid crystal display panel according to Embodiment 5.

The liquid crystal display devices including the liquid crystal display panels of Embodiments 1 to 5 can suitably include components (such as a light source) included in usual liquid crystal display devices. In addition, the array substrates (thin film transistor array substrates) included in the liquid crystal display panels of Embodiment 1 to 5 can suitably achieve the effect of the present invention to improve the transmittance when these array substrates are used in liquid crystal display devices.

In each embodiment described above, the liquid crystal display can be easily manufactured and high transmittance can be achieved. In particular, the liquid crystal display devices described in Embodiments 1 to 4 can be operated in a field sequential mode, and can achieve a response speed suitable for applications in in-vehicle devices and 3D display devices. In particular, it is preferred that a liquid crystal driving device performs field sequential driving and includes a circularly polarizing plate. The field sequential driving does not require color filters, thus resulting in increased internal reflection. This is because the transmittance of the color filters is usually ⅓, and the reflected light transmits through the color filters twice, therefore, the internal reflection is about 1/10 when the color filters are present. The use of a circularly polarizing plate can sufficiently reduce such internal reflection. The configurations of such as electrode structures of the liquid crystal display panel, the liquid crystal display device, and the thin film transistor array substrate of the present invention can be observed by microscopic observation of the TFT substrate and the counter substrate using a device such as scanning electron microscope (SEM).

### Comparative Example 1

FIG. 31 is a plan view showing a pixel of a liquid crystal display panel according to Comparative Example 1. In the liquid crystal display panel of Comparative Example 1, the linear electrode portions (lines) become dark lines D as in the above-described embodiments. Yet, unlike the configurations of Embodiments 1, 3, and 4, the main stem at the center has an ineffective region (rhombic portion). Thus, the transmittance is low. In addition, unlike the configurations of Embodiments 2 and 3, the main stem at the periphery does not contribute to the transmittance. This also results in low transmittance.

Thus, the liquid crystal display panel of Comparative Example 1 has low transmittance, compared to any of the liquid crystal display panels of Embodiments 1 to 4. The transmittance of the liquid crystal display panel of Comparative Example 1 is herein assumed to be 100% as a reference.

### Comparative Example 2

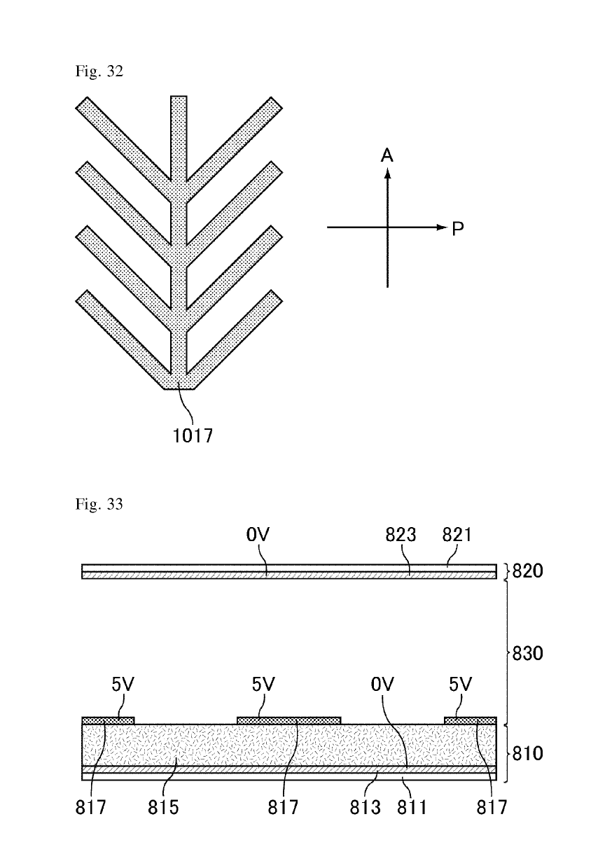

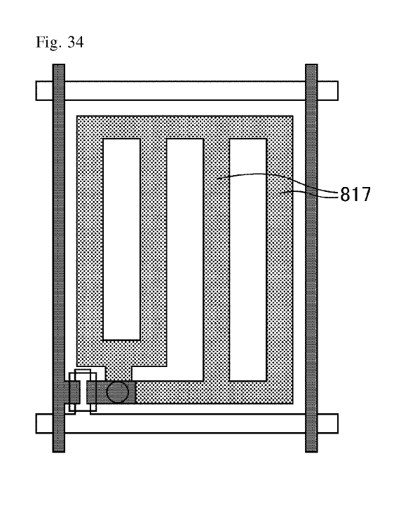

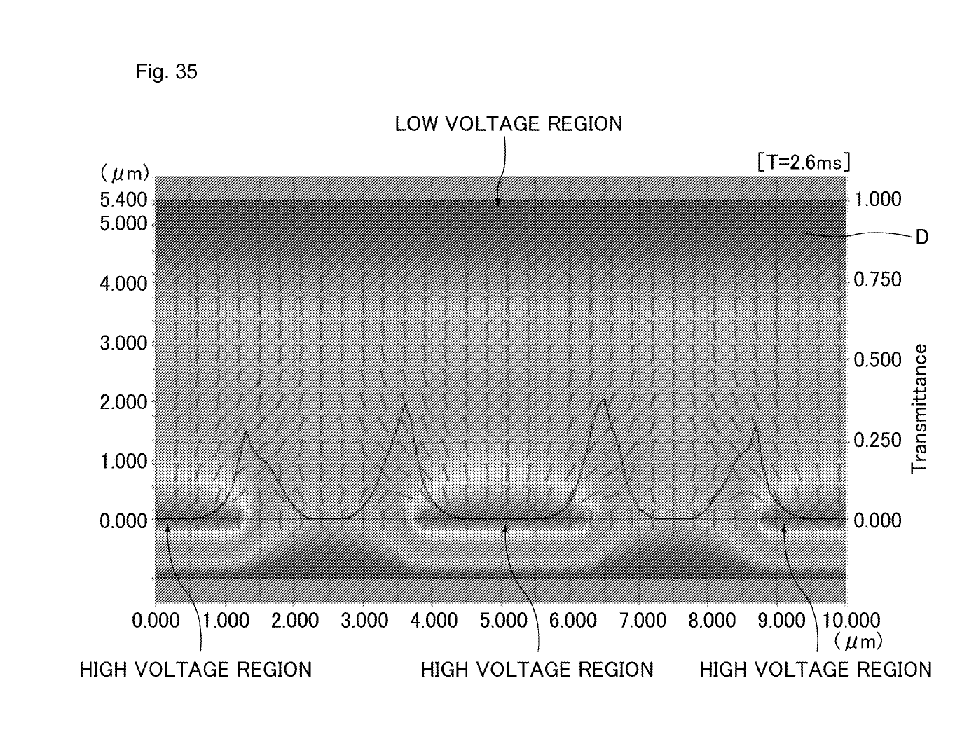

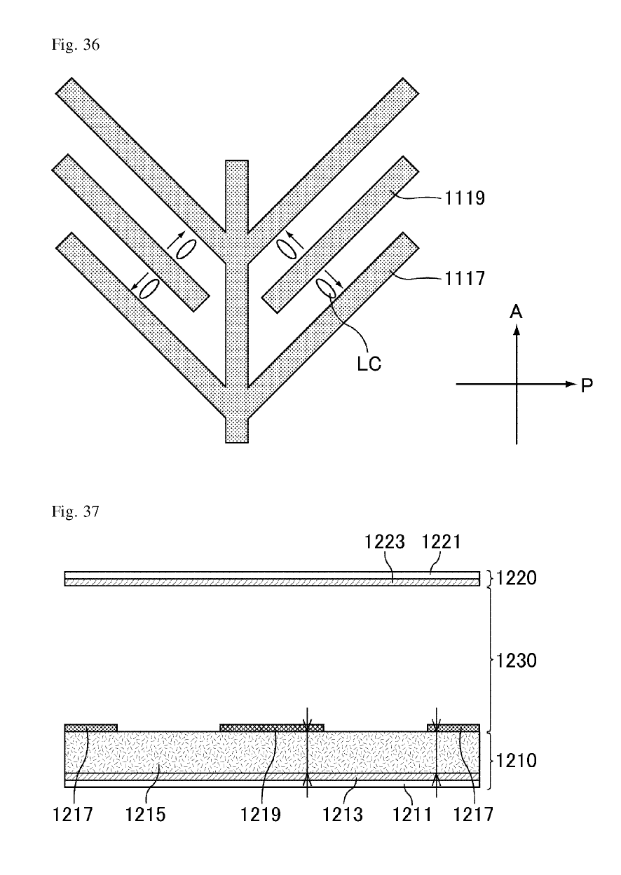

FIG. 32 is a schematic plan view showing a pixel of a liquid crystal display panel according to Comparative Example 2. Also in Comparative Example 2, the fishbone structure is divided into four sections in order to tilt the liquid crystal molecules in four directions, as in Embodiment 5. FIG. 32 shows only one stem as a part of the fishbone structure. The branched section of the electrode shown in FIG. 32 is configured in such a manner that the edge of the stem is in parallel to a pixel array direction (vertical direction in the figure), in other words, it is parallel to the orientation A of the analyzer. As a result, Comparative Example 2 exhibits lower transmittance than the liquid crystal display panel of Embodiment 5.

### Other Preferred Embodiment

In each embodiment of the present invention, an oxide semiconductor TFT (e.g. IGZO) is preferably used. The oxide semiconductor TFT will be described in detail below.

At least one of the upper and lower substrates usually includes a thin film transistor element. The thin film transistor element preferably includes an oxide semiconductor. Specifically, in the thin film transistor element, an active layer of an active drive element (TFT) is preferably formed using an oxide semiconductor film such as zinc oxide instead of a silicon semiconductor film. Such a TFT is referred to as an “oxide semiconductor TFT”. The oxide semiconductor characteristically shows a higher carrier mobility and less unevenness in its properties than amorphous silicon. Thus, the oxide semiconductor TFT moves faster than an amorphous silicon TFT, has a high driving frequency, and is suitably used for driving of next-generation display devices with higher definition. In addition, the oxide semiconductor film is formed by an easier process than a polycrystalline silicon film, and it is thus advantageously applicable to devices requiring a large area.

The following characteristics markedly appear especially in the case where the liquid crystal driving method of the present embodiment is applied to field sequential display devices (FSDs).

(1) The pixel capacitance is higher than that in a usual VA (vertical alignment) mode (FIG. 37 is a schematic cross-sectional view showing an example of a liquid crystal display device used in the liquid crystal driving method of the present embodiment; in FIG. 37, a large capacitance is generated between the upper layer electrode and the lower layer electrode at the portion indicated by an arrow so that the pixel capacitance is higher than that in the liquid crystal display device in usual vertical alignment (VA) mode). (2) One pixel in the FSD is equivalent to three pixels (RGB), and thus the capacitance of one pixel is trebled. (3) The gate ON time is very short because 240 Hz or higher driving is required.

Further, advantages of applying the oxide semiconductor TFT (e.g. IGZO) are as follows.

Because of the reasons described in (1) and (2) above, a 52-inch device has a pixel capacitance of at least about 20 times as high as a 52-inch UV2A 240-Hz drive device.

Thus, a transistor produced using conventional a-Si is as large as about 20 times or more, unfortunately resulting in an insufficient aperture ratio.

The mobility of IGZO is about 10 times that of a-Si, and thus the size of the transistor is about 1/10.

Although the liquid crystal display device using color filters (RGB) has three transistors, the FSD has only one transistor. Thus, the device can be produced in a size as small as or smaller than that in which a-Si is used.

As the size of the transistor becomes smaller as described above, the Cgd capacitance also becomes smaller. This reduces the load on the source bus lines.

### Specific Examples

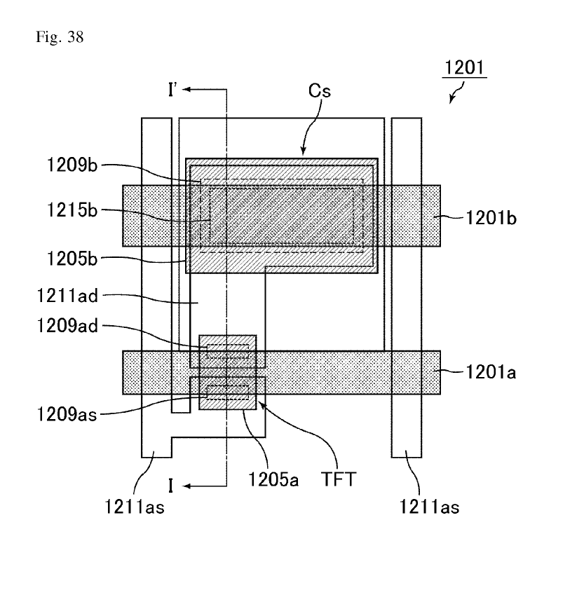

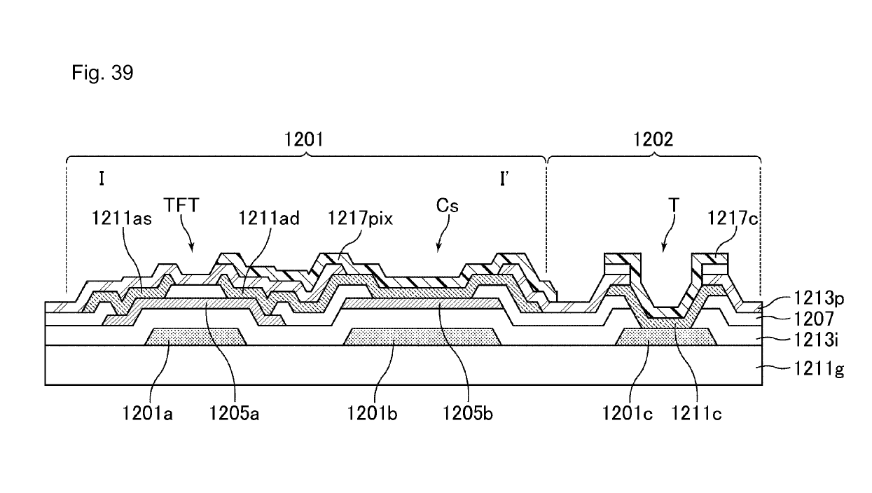

FIG. 38 and FIG. 39 each show a configuration diagram (example) of the oxide semiconductor TFT. FIG. 38 is a schematic plan view showing an active drive element and its vicinity used in the present embodiment. FIG. 39 is a schematic cross-sectional view showing the active drive element and its vicinity used in the present embodiment. A reference sign T indicates gate and source terminals. A reference sign Cs indicates an auxiliary capacitance.

An example (the relevant portion) of a production process of the oxide semiconductor TFT will be described below.

Active layer oxide semiconductor layers 1205a and 1205b of an active drive element (TFT) including an oxide semiconductor film are formed as described below.

First, an In—Ga—Zn—O semiconductor (IGZO) film with a thickness of 30 nm or more but 300 nm or less, for example, is formed on an insulating layer 1213i by sputtering. Then, a resist mask is formed by photolithography so as to cover predetermined regions of the IGZO film. Next, portions of the IGZO film other than the regions covered by the resist mask are removed by wet etching. Thereafter, the resist mask is peeled off. This provides island-shaped oxide semiconductor layers 1205a and 1205b. The oxide semiconductor layers 1205a and 1205b may be formed using other oxide semiconductor films instead of the IGZO film. [0098]

Next, an insulating layer 1207 is deposited on the whole surface of a substrate 1211g and the insulating layer 1207 is patterned.

Specifically, first, an SiO₂ film (thickness: about 150 nm, for example) as the insulating layer 1207 is formed on the insulating layer 1213i and the oxide semiconductor layers 1205a and 1205b by CVD. The insulating layer 1207 preferably includes an oxide film such as SiOy.

The use of the oxide film can recover oxygen deficiency on the oxide semiconductor layers 1205a and 1205b by the oxygen contained in the oxide film, and thus can more effectively suppress oxygen deficiency on the oxide semiconductor layers 1205a and 1205b. Here, a single layer of an SiO₂ film is used as the insulating layer 1207. Yet, the insulating layer 1207 may have a stacked structure of an SiO₂ film as a lower layer and an SiNx film as an upper layer.

The thickness (in the case of a stacked structure, the total thicknesses of the layers) of the insulating layer 1207 is preferably 50 nm or more but 200 nm or less. The insulating layer with a thickness of 50 nm or more can more reliably protect the surfaces of the oxide semiconductor layers 1205a and 1205b in the step of patterning the source and drain electrodes and other steps. If the thickness of the insulating layer exceeds 200 nm, larger steps will be formed on the source electrode and the drain electrode, which may cause disconnection.

The oxide semiconductor layers 1205a and 1205b in the present embodiment are preferably formed from a Zn—O semiconductor (ZnO), an In—Ga—Zn—O semiconductor (IGZO), an In—Zn—O semiconductor (IZO), a Zn—Ti—O semiconductor (ZTO), or the like. Among these, an In—Ga—Zn—O semiconductor (IGZO) is more preferred.

The present mode provides certain effects in combination with the above oxide semiconductor TFT. Yet, the present mode can be driven using a known TFT element such as an amorphous Si TFT or a polycrystalline Si TFT.

Each embodiment described above is configured to include an overcoat layer in the counter substrate. While the overcoat layer is preferably included, it does not have to be included. As the electrode material, a known material such as indium zinc oxide (IZO) or the like can be used instead of ITO.

### REFERENCE SIGNS LIST

10, 110, 210, 410, 510, 610, 710, 810, 1210: array substrate
11, 21, 111, 121, 411, 421, 511, 521, 611, 621, 711, 721, 811, 821, 1211, 1221: glass substrate
13, 113, 213, 313, 413, 513, 613, 813, 1213: lower layer electrode (common electrode)
15, 115, 415, 515, 615, 1215: insulating layer
16: a pair of comb-shaped electrodes
17, 19, 117, 119, 217, 219, 317, 319, 417, 419, 517, 519, 617, 619, 917, 917′, 919, 919′, 1017, 1017′, 1019, 1019′, 1117, 1119, 1217, 1219: comb-shaped electrode
20, 120, 220, 420, 520, 1220: counter substrate
23, 123, 223, 323, 423, 523, 623, 1223: common electrode
25, 125, 425, 625: overcoat layer
30, 130, 230, 430, 530, 1230: liquid crystal layer
31, LC: liquid crystal (liquid crystal molecules)
717, 1017: fishbone-shaped electrode
817: slit electrode
1201a: gate wire
1201b: auxiliary capacitance wire
1201c: connection site
1211g: substrate
1213i: insulating layer (gate insulator)
1205a, 1205b: oxide semiconductor layer (active layer)
1207: insulating layer (etching stopper, protection film)
1209 as, 1209ad, 1209b, 1215b: opening portion
1211 as: source wire
1211ad: drain wire
1211c, 1217c: connection site
1213p: protection film
1217 pix: pixel electrode
1201: pixel portion
1202: terminal arrangement region
Cs: auxiliary capacitance
T: gate and source terminals
A: orientation of analyzer
P: orientation of polarizer

1. A liquid crystal display panel comprising a first substrate, a second substrate, and a liquid crystal layer interposed between the first and second substrates,
wherein the first substrate comprises an electrode having a T-shaped branched section, and
the electrode comprises linear portions forming the T-shaped branched section and separately extending in directions different from a pixel array direction.

2. The liquid crystal display panel according to claim 1,
wherein the linear portions forming the T-shaped branched section of the electrode each form an angle of substantially 45° with a pixel array direction.

3. The liquid crystal display panel according to claim 1,
wherein the electrode of the first substrate comprises a zigzag stem.

4. The liquid crystal display panel according to claim 1,
wherein the first substrate comprises a pair of comb-shaped electrodes, and
at least one of the pair of comb-shaped electrodes is the electrode having the T-shaped branched section.

5. The liquid crystal display panel according to claim 4,
wherein the liquid crystal display panel is configured in such a manner that liquid crystal molecules in the liquid crystal layer are aligned horizontally to the main faces of the substrates by an electric field generated between the pair of comb-shaped electrodes or between the first substrate and the second substrate.

6. The liquid crystal display panel according to claim 1,
wherein the liquid crystal layer comprises liquid crystal molecules aligned vertically to the main faces of the substrates at a voltage lower than a threshold voltage.

7. A liquid crystal display panel comprising a first substrate, a second substrate, and a liquid crystal layer interposed between the first and second substrates,
wherein the first substrate comprises an electrode,
at least a portion of the electrode is a linear portion extending along at least a portion of a periphery of a pixel, and the electrode comprises a slit along the periphery of the pixel, and
at least a portion of an edge of the slit is oriented in a direction different from a pixel array direction.

8. The liquid crystal display panel according to claim 7,
wherein the first substrate comprises a pair of comb-shaped electrodes, and
at least a portion of the electrode of the first substrate is a stem of at least one of the pair of comb-shaped electrodes.

9. The liquid crystal display panel according to claim 1,
wherein the first substrate further comprises a planar electrode.

10. The liquid crystal display panel according to claim 1,
wherein the first substrate comprises a thin film transistor element, and
the thin film transistor element comprises an oxide semiconductor.

11. A liquid crystal display device comprising the liquid crystal display panel as defined in claim 1.

12. A thin film transistor array substrate comprising a thin film transistor element,
wherein the thin film transistor array substrate is for use in a liquid crystal display device, and comprises an electrode including a T-shaped branched section, and
the electrode includes linear portions forming the T-shaped branched section and separately extend in directions different from a pixel array direction.

13. A thin film transistor array substrate comprising a thin film transistor element,
wherein the thin film transistor array substrate is for use in a liquid crystal display device and comprises an electrode,
at least a portion of the electrode is a linear portion extending along at least a portion of a periphery of a pixel, and the electrode comprises a slit along the periphery of the pixel, and
at least a portion of an edge of the slit is oriented in a direction different from a pixel array direction.
